(19) United States
(12) Patent Application Publication
(10) Pub. No.: US 2026/0320755 A1
(43) Pub. Date: Oct. 15, 2026

(54) IMAGE FILTER WITH CLASSIFICATION BASED CONVOLUTION KERNEL SELECTION

(71) Applicant: FRAUNHOFER-GESELLSCHAFT ZUR FÖRDERUNG DER ANGEWANDTEN FORSCHUNG E.V., München (DE)

(72) Inventors: Wang-Q LIM, Berlin (DE); Jonathan PFAFF, Berlin (DE); Heiko SCHWARZ, Berlin (DE); Detlev MARPE, Berlin (DE); Thomas WIEGAND, Berlin (DE)

(21) Appl. No.: 19/692,887

(22) Filed: May 29, 2026

Related U.S. Application Data
(63) Continuation of application No. PCT/EP2024/084172, filed on Nov. 29, 2024.

(30) Foreign Application Priority Data
Dec. 1, 2023 (EP) 23213793.5

(51) Int. Cl. G06T 5/60; G06N 3/0464

(52) U.S. Cl. CPC G06T 5/60; G06N 3/0464; G06T 2207/20084

(57) ABSTRACT

Embodiments are related to an image filter configured to: obtain a picture; perform a first and second sample-wise classification of the picture; select, sample-wise, first convolution kernels from a first set of convolution kernels, based on the first classification; and second convolution kernels from a second set of convolution kernels, based on the second classification; perform, in one or more convolution layers of the image filter, on the picture or on a pre-processed version of the picture, a sequence of one or more first convolutions using the selected first convolution kernels, in order to provide a plurality of first convolution outputs and a sequence of one or more second convolutions using the selected second convolution kernels, in order to provide a plurality of second convolution output; and combine the first and second convolution outputs, in order to obtain a plurality of combined convolution outputs.

### CROSS-REFERENCE TO RELATED APPLICATIONS

This application is a continuation of copending International Application No. PCT/EP2024/084172, filed Nov. 29, 2024, which is incorporated herein by reference in its entirety, and additionally claims priority from European Application No. EP 23213793.5, filed Dec. 1, 2023, which is also incorporated herein by reference in its entirety.

Embodiments according to the invention comprise image filters with classification based convolution kernel selection.

Embodiments according to the invention comprise simplified CNN (convolutional neural network) based in-loop filters with fixed classifications.

### BACKGROUND OF THE INVENTION

Sophisticated image filters often comprise a significant complexity, resulting in large computational costs and large numbers of parameters, which are to be trained or optimized.

Hence, there is a need for a concept for image filtering which allows achieving a better compromise between an improvement of the filtered image (e.g. image quality, e.g. improvement for use of the image for motion compensation), a computational complexity and a number of parameters needed for the filtering.

This is achieved by the subject matter of the independent claims of the present application.

Further embodiments according to the invention are defined by the subject matter of the dependent claims of the present application.

### SUMMARY

An embodiment may have an image filter configured to: obtain a picture; perform, sample-wise or block-wise, a first classification of the picture; perform, sample-wise or block-wise, a second classification of the picture; select, sample-wise or block-wise, first convolution kernels from a first set of convolution kernels, based on the first classification; select, sample-wise or block-wise, second convolution kernels from a second set of convolution kernels, based on the second classification; perform, in one or more convolution layers of the image filter, a sequence of one or more first convolutions on the picture or on a pre-processed version of the picture, using the selected first convolution kernels, in order to provide a plurality of first convolution outputs; perform, in the one or more convolution layers of the image filter, a sequence of one or more second convolutions on the picture or on the pre-processed version of the picture, using the selected second convolution kernels, in order to provide a plurality of second convolution outputs; and combine the first and second convolution outputs, in order to obtain a plurality of combined convolution outputs.

Another embodiment may have a decoder including an inventive image filter and an image buffer, wherein the decoder is configured to: obtain an encoded representation of the picture from a bitstream; reconstruct, based on the bitstream, the picture using block-based predictive decoding and a prediction loop, the prediction loop including the image filter; buffer the reconstructed picture in the image buffer.

Another embodiment may have an encoder including an inventive image filter and an image buffer, configured to: obtain the picture; perform a block-based predictive encoding of the picture, using a prediction loop including the image filter, in order to provide an encoded version of the picture to a bitstream.

According to another embodiment, a method for image filtering may have the steps of: obtaining a picture; performing, sample-wise or block-wise, a first classification of the picture; performing sample-wise or block-wise, a second classification of the picture; selecting, sample-wise or block-wise, first convolution kernels from a first set of convolution kernels, based on the first classification; selecting, sample-wise or block-wises, second convolution kernels from a second set of convolution kernels, based on the second classification; performing, in one or more convolution layers of the image filter, a sequence of one or more first convolutions on the picture or on the pre-processed version of the picture, using the selected first convolution kernels, in order to provide a plurality of first convolution outputs; performing, in the one or more convolution layers of the image filter, a sequence of one or more second convolutions on the picture or on a pre-processed version of the picture, using the selected second convolution kernels, in order to provide a plurality of second convolution outputs; and combining the first and second convolution outputs, in order to obtain a plurality of combined convolution outputs.

Another embodiment may have a method for decoding an encoded representation of a picture, wherein the method includes obtaining the encoded representation of the picture from a bitstream; wherein the method comprises reconstructing, based on the bitstream, the picture by using block-based predictive decoding and a prediction loop, the prediction loop including an image filter and by performing the inventive method for image filtering; and wherein the method includes buffering the reconstructed picture in the image buffer.

Another embodiment may have a method for providing an encoded representation of a picture, wherein the method includes obtaining the picture; wherein the method includes performing a block-based predictive encoding of the picture, by using a prediction loop including an image filter and by performing the inventive method for image filtering, in order to provide the encoded representation of the picture to a bitstream.

Another embodiment may have a non-transitory digital storage medium having a computer program stored thereon to perform any of the inventive methods when said computer program is run by a computer.

Another embodiment may have a bitstream having encoded therein a picture using the inventive method for providing an encoded representation of a picture.

Embodiments according to the invention comprise an image filter, e.g. a prediction loop filter, e.g. for video coding, e.g. a neural network image filter, e.g. a convolutional neural network filter. The filter is configured to obtain (e.g. receive, e.g. be provided with) a picture (e.g. a frame of a video, e.g. a frame of a video stream, e.g. a reconstructed version of a picture, e.g. a reconstructed version of a target picture). Furthermore, the filter is configured to perform, sample-wise (e.g. pixel-wise; e.g. for each sample), or block-wise (e.g. for a plurality of neighboring sampels, e.g. for n×n samples, e.g. for 3×3 or 2×2 samples), a first classification (e.g. fixed classification, e.g. non-neurally performed classification, e.g. by use of FIR filters) of the picture (e.g. in order to map sample indices or block indices and/or samples or blocks, e.g. each sample or block, of the picture to classes of a first set of classes) and to perform, sample-wise (e.g. pixel-wise; e.g. for each sample) or block-wise, a second, e.g. different from the first, classification (e.g. fixed classification, e.g. non-neurally performed classification, e.g. by use of FIR filters) of the picture (e.g. in order to map sample indices, block indices and/or samples or blocks, e.g. each sample or each block of the picture to classes of a second set of classes, which is, for example, different from the first set of classes).

Moreover, the filter is configured to select, sample-wise or block-wise, e.g. pixel-wise; e.g. for each sample, e.g. for each block, first convolution kernels (e.g. sample-wise matrices of dimension k×k, e.g. sample-wise tensors, e.g. sample-wise scalars) from a first set of convolution kernels, based on the first classification and to select, sample-wise or block-wise, e.g. pixel-wise; e.g. for each sample, e.g. for each block, second convolution kernels (e.g. sample-wise matrices of dimension k×k, e.g. sample-wise tensors, e.g. sample-wise scalars) from a second set of convolution kernels, based on the second classification.

The filter is configured to perform, in one or more convolution layers of the image filter, a sequence of one or more first, e.g. sample-wise or block-wise, convolutions on the picture or on a pre-processed, e.g. filtered or convoluted, version of the picture, using the selected first convolution kernels, e.g. using individually selected kernels for each sample or block, in order to provide a plurality of first convolution outputs, e.g. p first convolution outputs, e.g. p first channels, to perform, in the one or more convolution layers of the image filter, a sequence of one or more second, e.g. sample-wise or block-wise, convolutions on the picture or on the pre-processed, e.g. filtered or convoluted, version of the picture, using the selected second convolution kernels, e.g. using individually selected kernels for each sample or block, in order to provide a, e.g. same, plurality of second convolution outputs, e.g. p second convolution outputs, e.g. p second channels and to combine, e.g. add, e.g. add in an element-wise and/or sample-wise manner, the first and second convolution outputs, in order to obtain a, e.g. same, plurality of combined convolution outputs, e.g. p combined convolution outputs, e.g. p combined channels.

Embodiments according to the invention are based on the idea to perform a plurality of sample-wise, e.g. pixel-wise, or block-wise, classifications for an image (e.g. a picture, e.g. luma picture, e.g. a (for example reconstructed) frame of a video stream) and to select sample-wise or respectively block-wise convolutional kernels based on a respective class of the respective classification.

Hence, as an example, for each sample (or each block comprising a number of samples, e.g. a 2×2 block or a 4×4 block), a number of m, e.g. 2, e.g. 3, classifications may be performed, so as to categorize each sample or block into m classes (e.g. out of m different sets of classes, wherein the different sets of classes may have different numbers of classes). Each of the m classes of a sample or block may hence define at least one convolution kernel for filtering the sample or block (respectively sample or block position), or even a plurality of convolution kernels, e.g. for successive filtering steps of the input image in successive layers of the image filter. Respective second and following kernels, may hence define a filtering of the pre-filtered (with the first kernels) sample position or block position.

The image filter may perform different filtering procedures, e.g. according to the m classifications, via successive layers in parallel and/or by combining filtering results, e.g. as a weighted summation, based on convolution kernels of different classifications.

Hence, sample-wise or block wise, and classification-wise filterings of the image, e.g. of a frame of a video stream, may allow a highly adaptive and efficient image filtering, e.g. for use as or for determining a reference picture (e.g. for motion compensation) to increase coding efficiency.

Furthermore, it is to be noted that the classification may in particular be a predefined, e.g. fixed, classification, hence keeping computational costs low, while allowing classifying respective samples or blocks for the adaptive choice of filtering kernels.

In particular, image filters according to embodiments may allow improving a residual between a target picture and the obtained picture. The obtained picture (e.g. as the input of the filter), may be a reconstructed version of the target picture, so that the target picture may be an original, e.g. uncompressed version of the reconstructed picture. In other words, in the context of video coding, an image filter according to embodiments may be implemented in a prediction loop (e.g. in a respective encoder, e.g. in a respective decoder), in order to be provided with a reconstructed version of a target picture, e.g. as a reconstructed frame of a video stream.

The filter may hence perform the above-discussed filtering with sample- and/or block-wise, as well as classification-wise, chosen convolution kernels, in order to provide a residual signal for combination, e.g. in the form of an addition, with the reconstructed version of the picture, e.g. y, e.g. Y, in order to approximate the original, uncompressed version of the picture, e.g. y.

Hence, this may allow encoding a respective video stream, because of an improved residual encoding, more efficiently. Furthermore, an improved quality of the decoded version of the video stream may be achieved.

Some embodiments comprise methods for image filtering. It is to be noted, that such embodiments may be based on the same ideas and principles as a respective image filter. Hence, a corresponding method may comprise same, similar, identical or corresponding features and functionalities, both individually or taken in combination, as a respective image filter.

Furthermore, embodiments according to the invention comprise an apparatus for neural network based image filtering, the apparatus comprising a convolutional layer and one or more subsequent layers. The apparatus is configured to perform, for each filter kernel set out of a set of filter kernel sets, a picture classification in a spatially sampling manner so as to obtain, for each filter kernel position of filter kernel positions distributed over the picture, a selected local picture classification out of a set of local picture classifications within which each local picture classification is associated with a respective filter kernel out of the respective filter kernel set and a weight for each of weighted sum combinations.

The apparatus is further configured to, in the convolutional layers, subject the picture to, for each filter kernel set out of the filter kernel sets, a convolution using the respective filter kernel set by applying to each filter kernel position the filter kernel associated with the selected picture classification obtained for the respective filter kernel position so as to obtain, for the respective filter kernel set, a filtered input channel

The apparatus is further configured to, in the one or more subsequent layers, form the weighted sum combinations of the filtered input channels obtained for the filter kernel sets, with, for each weighted sum combination, weighting, at each filter kernel position, each filtered input channel using the weight which is associated with the selected picture classification obtained for the respective filter kernel position, and based on the weighted sum combinations, determine a filtered picture of the picture.

### BRIEF DESCRIPTION OF THE DRAWINGS

Embodiments of the present invention will be detailed subsequently referring to the appended drawings, in which:

FIG. 1 a schematic view of an image filter according to embodiments of the invention;

FIG. 2 a schematic view of a picture classification according to embodiments of the invention;

FIG. 3 a schematic view of a kernel selection according to embodiments of the invention;

FIG. 4 a schematic view of a first convolution according to embodiments of the invention;

FIG. 5 a schematic view of a first and second convolution according to embodiments of the invention;

FIG. 6 a schematic view of optional convolutions using a second subset of the selected first convolution kernels according to embodiments of the invention;

FIG. 7 a schematic view of the approach as discussed in the context of FIG. 6, performed accordingly for a second intermediate convolution output for providing the plurality of second convolution outputs;

FIG. 8 a schematic view of an optional, schematic example, for combining first and second convolution outputs, in order to obtain a plurality of combined convolution outputs, according to embodiments of the invention;

FIG. 9 a schematic view of an example for neighboring samples used in sample difference based classifications according to embodiments of the invention;

FIG. 10 a schematic view of a block diagram of a basic layer according to an embodiment of the invention;

FIG. 11 a schematic view of a block diagram of a concatenation layer according to an embodiment of the invention;

FIG. 12 a schematic view of a block diagram of an addition layer according to an embodiment of the invention;

FIG. 13a a schematic block diagram of a simplified CNN image filter with fixed classifications according to an embodiment of the invention;

FIG. 13b a schematic block diagram of a simplified CNN in loop image filter with fixed classifications according to an embodiment of the invention;

FIG. 14 a schematic view of a video encoder block diagram for a simplified CNN based in-loop filter according to embodiments of the invention;

FIG. 15 a schematic view of an image filtering procedure according to the architecture as shown in FIG. 13a;

FIG. 16 a schematic view of an image filtering in an optional further layer of the image filter according to an embodiment of the invention;

FIG. 17 a schematic view of a summation in an optional further layer of the image filter for obtaining combined concatenated convolution outputs according to an embodiment of the invention;

FIG. 18a a schematic view of the filter according to FIG. 13a, further highlighting an optional output convolution in the fourth layer according to an embodiment of the invention;

FIG. 18b a schematic view of the filter according to FIG. 18a, further highlighting an optional filtering according to an embodiment of the invention; and

FIG. 19 a schematic view of a decoder according to embodiments of the invention.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more throughout explanation of embodiments of the present invention. However, it will be apparent to those skilled in the art that embodiments of the present invention may be practiced without these specific details. In other instances, well-known structures and devices are shown in block diagram form rather than in detail in order to avoid obscuring embodiments of the present invention. In addition, features of the different embodiments described herein after may be combined with each other, unless specifically noted otherwise.

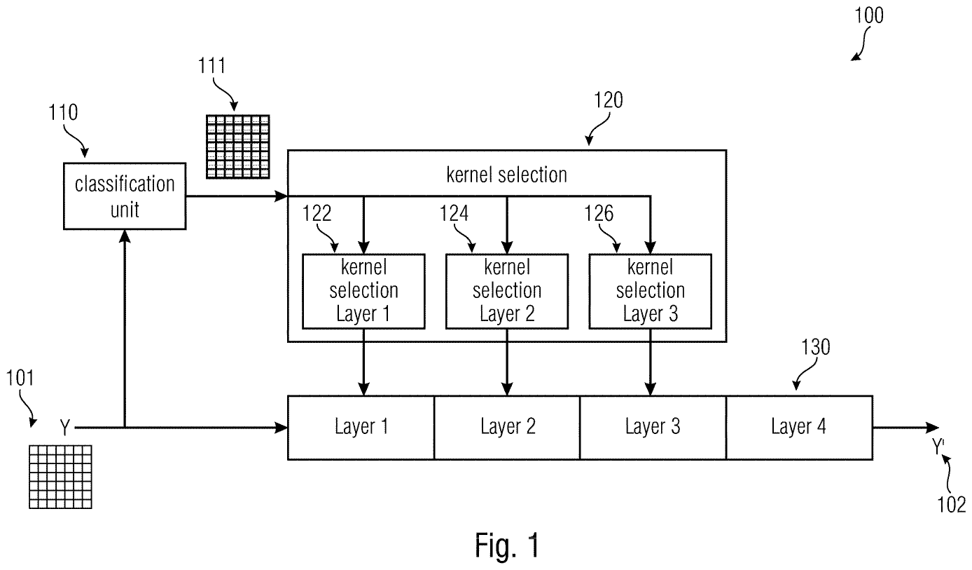

In the following description, for some explanations, for the sake of brevity, reference will be made to sample-wise (e.g. pixel-wise) functionalities. It is to be noted that each such functionality may be performed accordingly as a block-wise functionality, hence for a batch (e.g. an n×n batch, e.g. 2×2 or 4×4) of samples. For example, a respective square of the plurality of squares of an image, such as 101 and 111 in FIG. 1, as well as in the following figures, may be understood as individual samples of the image, or individual blocks. However, blocks may as well be defined in an overlapping manner (not shown).

In other words, for example in a block-wise classification, a same class index may be assigned to all samples (or sample positions) within a block of certain size (e.g. 2×2 or 4×4). So, a classification according to embodiments can be performed sample-wise or block-wise, to select kernels.

Reference is made to FIG. 1. FIG. 1 shows a schematic view of an image filter 100 according to embodiments of the invention. As shown in FIG. 1, image filter 100 is configured to obtain a picture Y, 101 (e.g. as a frame of a video stream, e.g. as a reconstructed frame of a video stream, e.g. hence a reconstructed picture, e.g. after inverse transformation from spectral to spatial domain, e.g. after inverse quantization, e.g. after dequantization).

Based on the picture 101, the image filter is configured to perform a first and second sample-wise or block-wise classification, using classification unit 110. For a respective sample or block and classification, an individual class is determined.

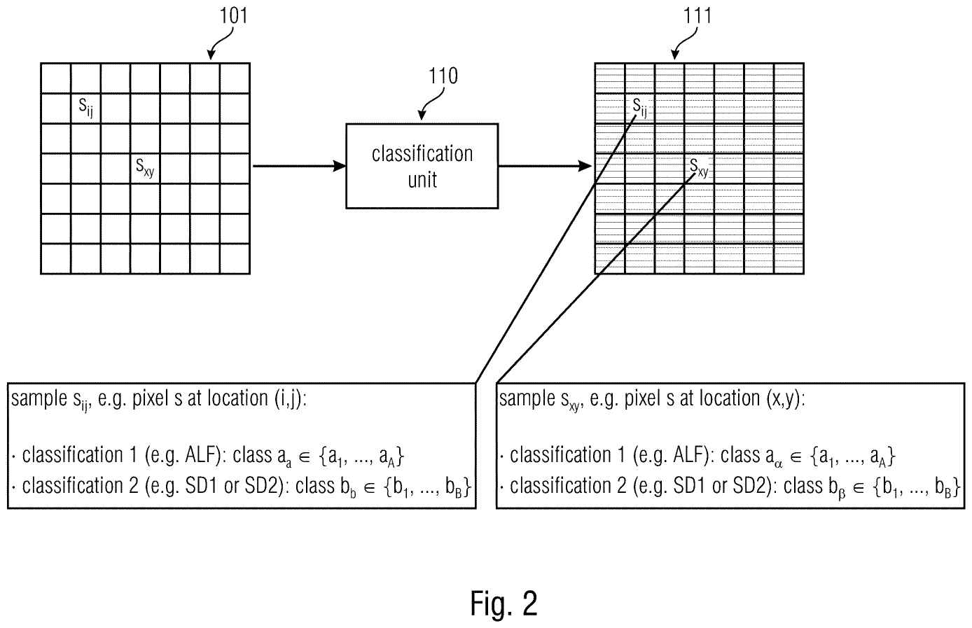

This is explained in detail in FIG. 2. FIG. 2 shows a schematic view of a picture classification according to embodiments of the invention. As explained before, for a respective sample, e.g. pixel, e.g. as shown sample sᵢⱼ, (or block), a first and second classification is performed. Hence, sample sᵢⱼ, e.g. pixel s at location (i,j) (or block bᵢⱼ, e.g. centered at location (i,j)), may be assigned in classification 1 (e.g. ALF) to a class aₐ∈{a₁, . . . , a_{A}} and in classification 2 (e.g. SD₁ or SD₂) to class b_{b}∈{b₁, . . . , b_{B}}.

It is to be noted that more than two classifications may be performed. In other words, for a sample or block, or optionally even each sample or block of the image 101, a number of classifications, e.g. m, e.g. three classifications, may be performed. The respective classifications may each comprise a number of classes. The different classifications may comprise different numbers of individual classes. As an example, a first classification may assign the sample or block to one of A classes, the second classification may assign the sample or block to one of B classes.

For illustrative purposes, a classified image 111 is shown in FIGS. 1 and 2. It is to be noted that the sample-wise or block-wise classification information may not necessarily be represented as information added to the image 101 itself. The sample-wise or block-wise classes of the different classifications may be provided in any form suitable, e.g. in matrix, tensor, vector and/or tabular form, e.g. irrespective of a specific luma information of a sample.

Returning, to FIG. 1, based on the at least first and second classification of the picture 101, first and second sample-wise or block-wise convolution kernels may be selected, in accordance with the sample-wise or block-wise classification. This may be performed in a kernel selection unit 120 of the filter 100.

As an optional feature, in FIG. 1, a layer-wise selection of first and second kernels, in respective kernel selection subunits 122, 124, 126, is shown. However, a sample-(or block-) and classification-wise kernel selection for only one layer of the filter 100 is possible as well.

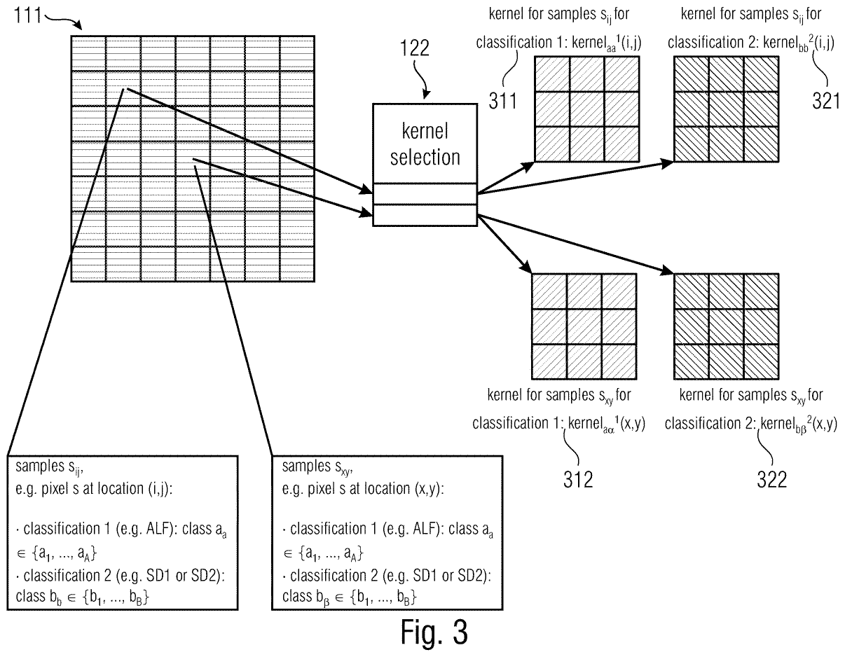

Reference is made to FIG. 3. FIG. 3 shows a schematic view of a kernel selection according to embodiments. Kernel selection 122 shown in FIG. 3 may correspond to kernel selection 122 in

FIG. 1, hence showing a kernel selection for convolutions in a first layer of the filter. However, as explained before, it is to be noted that such a layer-wise kernel selection is optional. The shown approach in FIG. 3 may as well correspond to kernel selection unit 120 in FIG. 1 as a whole (e.g. without the subunits), e.g. for selecting convolution kernels for a single layer, e.g. for selecting kernels in a non-layer-specific manner.

As explained before, a respective sample or block, e.g. sᵢⱼ, may be assigned to a first class, e.g. aₐ, as a result of the first classification and a second class, e.g. b_{b}, as a result of the second classification. A respective class may correspond to one or more convolution kernels.

The selected one or more specific convolution kernels of the respective class may hence define a convolution of the sample (or block) at the location (i,j) and/or a convolution of the sample (or block) at the location (i,j) of a processed version of the image, e.g. in a further layer of the image filter:

TABLE 1 (example)

| sᵢⱼ | Layer 1 | Layer 2 | . . . | Layer z |
|---|---|---|---|---|
| aₐ | Kernelₐₐ¹ | Kernelₐₐ² | . . . | Kernelₐₐ^{z} |
| b_{b} | Kernel_{bb}¹ | Kernel_{bb}² | . . . | Kernel_{bb}^{z} |

In other words, Kernelₐₐ¹, . . . , Kernelₐₐ^{z} may be predefined kernels (optionally of different dimensions and/or parameters) for the class aₐ for the first classification. Upon classifying sample sᵢⱼ, e.g. pixel s, (or block) at location (i,j) in the first classification to class aₐ, sample sᵢⱼ (and optionally its surrounding neighbors in case the kernel has a dimension n×n, with n>1) are optionally to be filtered in a first convolution using Kernelₐₐ¹. In subsequent layers, a sample of a respective convolution output at position (i,j) (and optionally its surrounding neighbors) may be convolved using a respective further kernel corresponding to the respective layer (e.g. for a second layer Kernelₐₐ²).

As an example, a whole row of the above table may hence, be selected as first convolution kernels for samples at position (i,j). As an example, Kernelₐₐ¹ may correspond to a kernel of a first subset of these first kernels, and Kernelₐₐ² may correspond to a kernel of a second subset of these kernels, e.g. for successive convolutions.

In other words, a class of a respective classification may be associated with at least one convolution kernel. Optionally a class may be associated with a plurality of convolution kernels, wherein respective kernels of the class may be used for convolving a respective sample or for example sample at a specific sample location, but in different layers of the image filter.

Hence, see FIG. 3, a sample sᵢⱼ, e.g. pixel s at location (i,j), may be assigned in a first classification 1 (e.g. ALF or SD₁ or SD₂) to a class aₐ∈{a₁, . . . , a_{A}} and in classification 2 (e.g. another one of ALF, SD₁ or SD₂) to class b_{b}∈{b₁, . . . , b_{B}}.

Beyond that, it is to be noted that respective kernels may comprise a third dimensionality, for example in order to change a number of channels, e.g. to perform a convolution of a single input image, in order to obtain a plurality of convoluted output images (e.g. for obtaining a plurality of output channels from a single input channel).

In FIG. 3, as an example, Kernelₐₐ¹ (i,j), 311, for class aₐ of classification 1 for sample sᵢⱼ at location (i,j), Kernel_{bb}²(i,j), 321, for class b_{b} of classification 2 for sample sᵢⱼ at location (i,j), Kernel_{aα}¹(x,y), 312, for class ag of classification 1 for sample s_{xy} at location (x,y), and Kernel_{bβ}²(x,y), 322, for class be of classification 2 for sample s_{xy} at location (x,y) are shown. The kernels are shown as 3×3 kernels as an example. However, other sizes, such as 5×5 are naturally possible. Here, it is to be noted that samples sᵢⱼ and s_{xy} or respectively corresponding sample locations (e.g. sample positions in the picture) may, for example, as well be assigned to a same class, e.g. for a same classification.

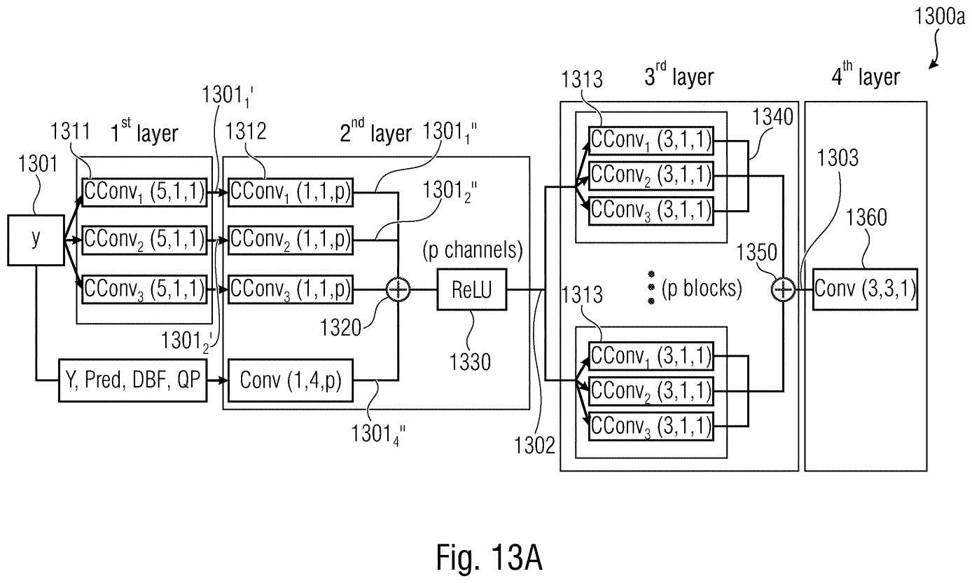

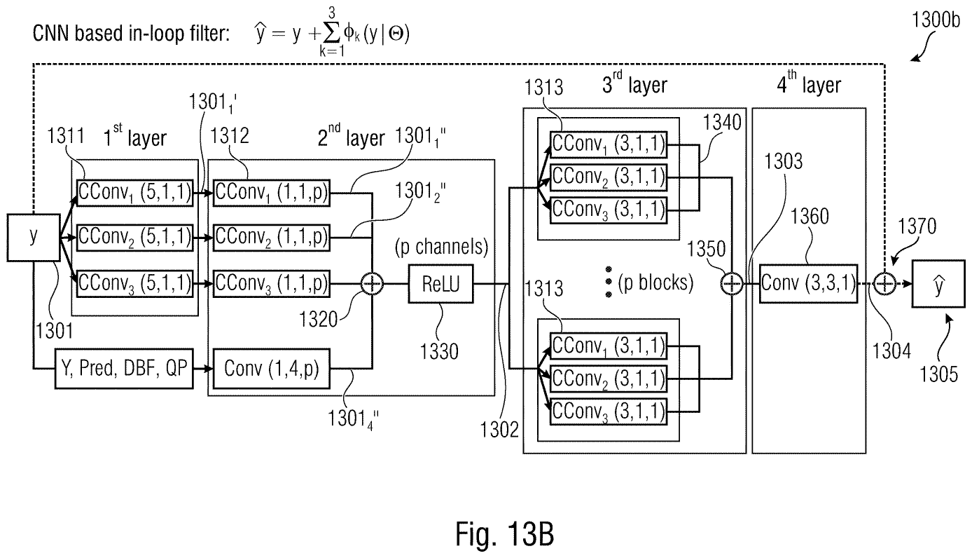

Referring back to FIG. 1, these convolution kernels may be used in a respective layers 130 (here e.g. layer 1 for the 3×3 kernels) of the filter 100 in order to obtain a plurality of combined convolution outputs. Based thereon, a filtered version Y′, 102, of the input image may be provided. According to some embodiments, the filtered version Y′ may represent a signal in order to improve, e.g. optimize, e.g. minimize, e.g. reduce a residual between a target picture and the obtained picture and/or an approximation of such a target picture. The difference in architecture may, for example, be an implementation of an additional sum, e.g. a sum 1370, as will be explained later in the context of FIG. 13b.

Here, it is to be noted that optionally, a table (or, for example, any other suitable representation of selectable classes or sets of classes, e.g. a table such as the above table 1) may have further dimensions or categories, for example for providing different sets of classes and hence kernels (e.g. for each classification), which may be considered (and hence selected) based on an information about a resolution of the picture, of a resolution class of the dataset comprising the picture and/or of a type of the picture.

As discussed before, the following explanations are focused on samples for simplicity. However, in a corresponding manner, a block-wise processing can be performed as well.

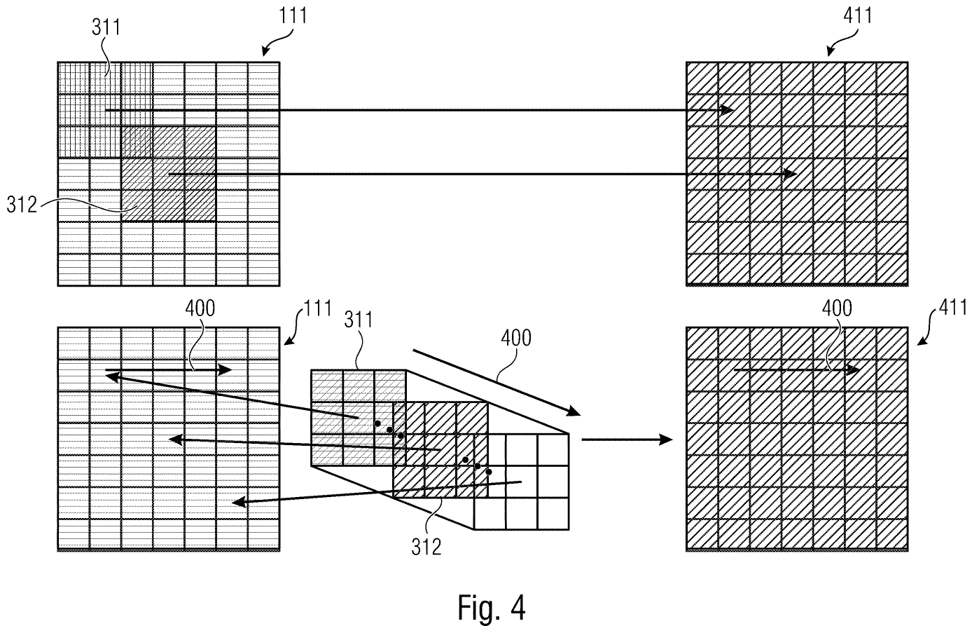

Reference is made to FIG. 4. FIG. 4 shows a schematic view of a first convolution (e.g. a portion thereof) according to embodiments of the invention. FIG. 4 shows an example for a sample-wise performance of a first convolution on the picture 111, using the selected first convolution kernels. As an example, the sample-wise convolutions, e.g. filterings, using kernels 311 and 312 are shown, which define respective samples, in an intermediate first convolution output 411 (see top of FIG. 4). The bottom half of FIG. 4 shows the same approach, further highlighting the sample-wise, 400, performance of the convolutions using respective first selected kernels.

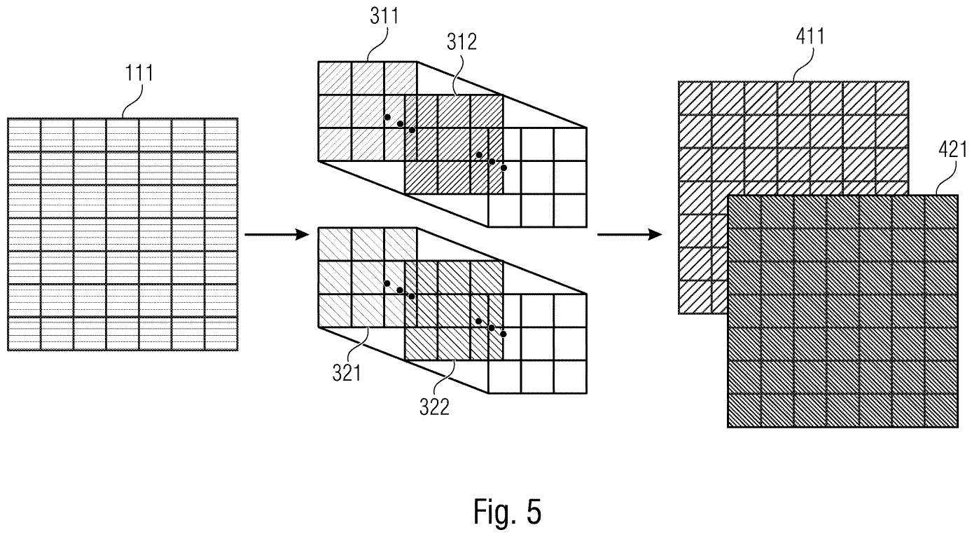

As shown in FIG. 5, the procedure may be performed for selected first kernels (e.g. for a first subset of all selected first kernels) of the first set of kernels, as well as for selected second kernels (e.g. for a first subset of all selected second kernels) of the second set of kernels, resulting in intermediate first convolution output 411 and intermediate second convolution output 421. Usage of intermediate outputs is, however, only optional. A convolution based on kernels defined for a first and second layer of the image filter may as well be performed in one-step.

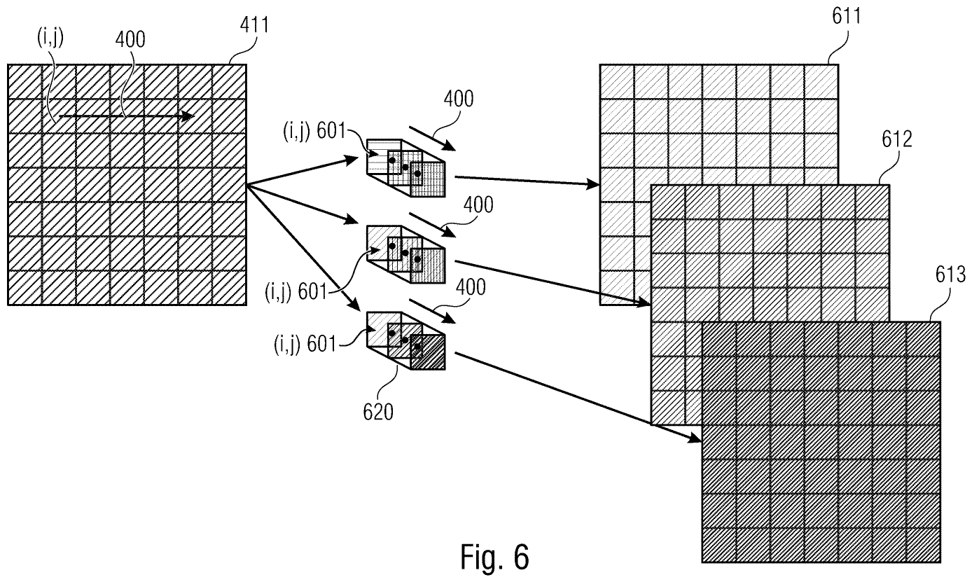

Reference is made to FIG. 6. FIG. 6 shows a schematic view of optional convolutions using convolution kernels of a second subset of the selected first convolution kernels according to embodiments of the invention. As shown in FIG. 6, the intermediate first convolution output 411 may be filtered by convolving the first intermediate convolution output 411 with respective convolution kernels of the second subset 620 of first convolution kernels, in order to provide the plurality of first convolution outputs 611, 612, 613.

As an example, this may be performed in a second layer of the filter. Referring to Table 1 discussed earlier, for sample location (i,j) associated with class aₐ, kernels Kernelₐₐ²(i,j) for such a second layer may be defined as shown by the plurality of kernels 601, e.g. as 1×1 kernels, but so as to provide p, here as an example p=3, first convolution outputs 611, 612, 613.

As shown in FIGS. 5 and 6, the intermediate convolution outputs 411 and 421 (first and second) may optionally be of a single channel.

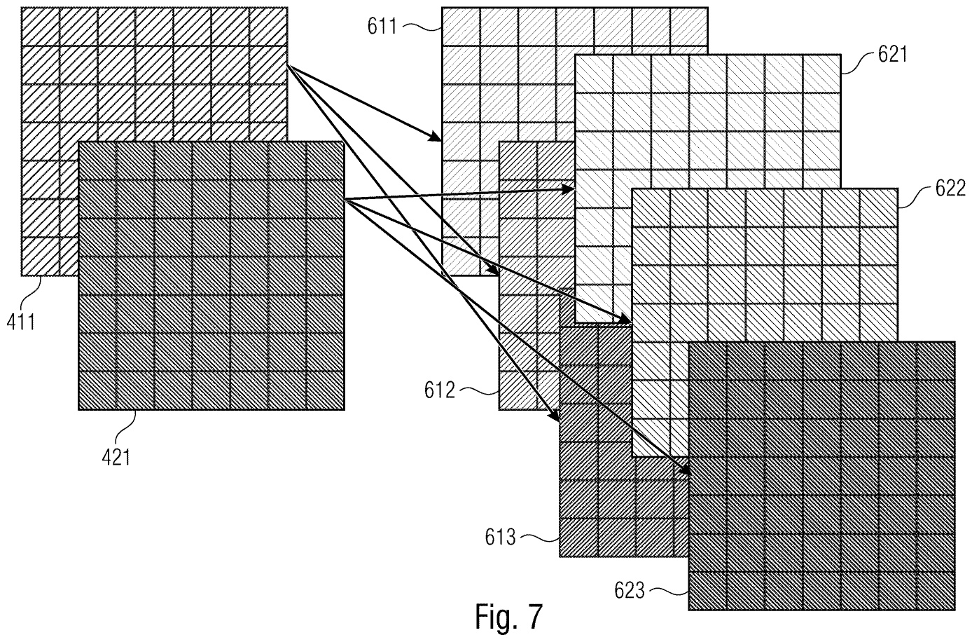

Referring to FIG. 7, the approach as discussed in the context of FIG. 6 may be performed accordingly for the second intermediate convolution output 421, for providing the plurality of second convolution outputs 621, 622, 623.

For the sake of simplicity, only 3 output channels for the convolution based on the second subset of the first and second selected convolution kernels are shown in FIGS. 6 and 7. However, more or less output channels, e.g. p=6 or p=8 output channels, are optionally possible as well.

In general, as shown in FIGS. 6 and 7, the image filter 100 may optionally be configured to increase a number of channels relative to the first intermediate convolution output 411 and the second intermediate convolution output 421 by convolving the first intermediate convolution output and the second intermediate convolution output with the second subset of first convolution kernels 620 and the second subset of second convolution kernels.

Here again, it is to be noted that a separation into first and second subsets of respective selected convolution kernels is optional. The inventors recognized that a separation of the selected convolution kernels into subsets, in order to perform sequential convolutions, instead of a single convolution, may allow reducing a computational complexity of the filtering.

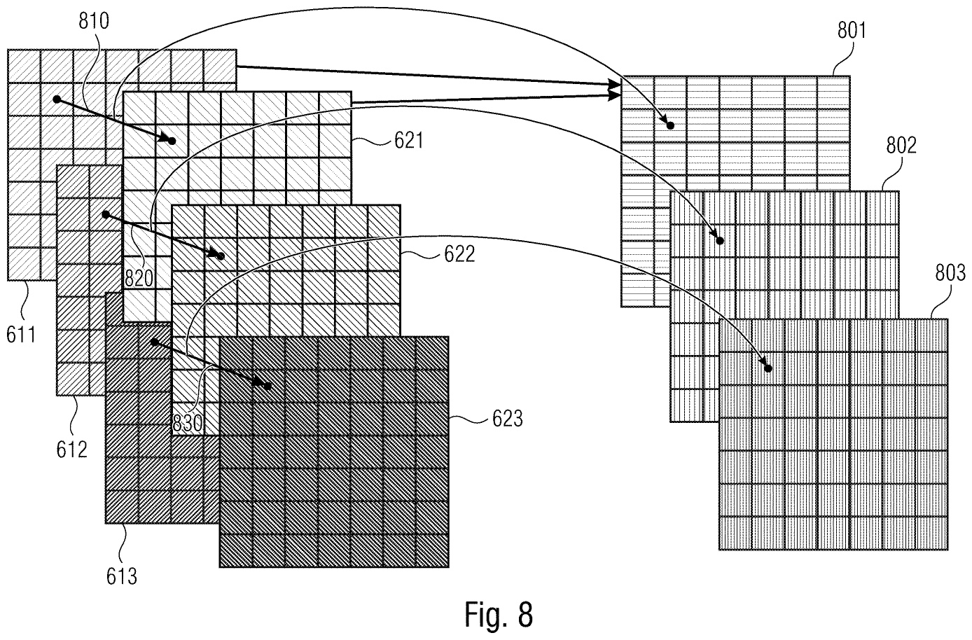

Next, reference is made to FIG. 8, showing a schematic example for combining the first and second convolution outputs 611, 612, 613 and 621, 622, 623, in order to obtain a plurality of combined convolution outputs 801, 802, 803.

Optionally, the plurality, e.g. p, of second convolution outputs, 621, 622, 623, and the plurality, e.g. p, of combined convolution outputs, 801, 802, 803, may be provided with a same number, e.g. p, of convolution outputs as the plurality, e.g. p, of first convolution outputs 611, 612, 613.

As shown in FIG. 8, the image filter 100, e.g. in a single layer, e.g. in layer 2, may optionally be configured to perform a sample-wise summation of the first convolution outputs 611, 612, 613 and the second convolution outputs 621, 622, 623, so that the second subset of the first convolution kernels and the second subset of the second convolution kernels form weighting factors, so as to form, along with the sample wise summation, a sample-wise weighted sum.

As shown in FIG. 8, the summation may be performed over convolution outputs of different classifications for same sample locations (see arrows 810, 820 and 830), defining respective samples in the combined convolution outputs. Hence, sample-wise summation of image 611 and 621 may provide image 801, sample-wise summation of image 612 and 622 may provide image 802 and sample-wise summation of image 613 and 623 may provide image 803.

As will be explained later, e.g. in the context of FIG. 13a, optionally, an image filter according to embodiments may be configured to perform the sample-wise or block-wise addition of respective first 611, 612, 613 and second 621, 622, 623 convolution outputs, in order to obtain a plurality intermediate combined convolution outputs, for example in order to obtain the plurality, e.g. p, of combined convolution outputs 801, 802, 803.

These intermediate combined convolution outputs may, for example, be offset and/or provided to a nonlinear activation function. An offset may be provided using constants, e.g. for each frame (e.g. for each output channel) and/or based on an additional intermediate convolution output. However, the offsetting and nonlinear activation are individually optional steps.

In this regard, it is to be noted that, for the following explanations, the shown convolution outputs 801, 802, 803 may as well represent such intermediate combined convolution outputs (e.g. directly after summation), such offset intermediate combined convolution outputs (with incorporated offset, not shown, in the additions, as indicated by 810, 820, 830) and/or the combined convolution outputs 801, 802, 803 after non-linear activation.

Referring back to FIG. 6, the second subset of the first convolution kernels and the second subset of the second convolution kernels (not shown in FIG. 6) may hence form weighting factors for the summation, so that the weighting is already “baked in” the respective first convolution outputs 611, 612, 613 and the respective second convolution outputs 621, 622, 623.

It is to be noted that for this summation, a plurality of additional intermediate convolution outputs may be added as well. Such additional convolution outputs may be based on the picture itself, a predicted version of the picture, e.g. Pred, a reconstructed version of the picture (e.g. an input frame for the deblocking filter) and/or a quantization parameter, e.g. QP.

However, embodiments may, for example, not be restricted to the above-discussed summation, but rather, in general, a combination of first 611, 612, 613 and second 621, 622, 623 convolution outputs and the additional intermediate convolution outputs may be performed, in order to obtain the plurality of combined convolution outputs 801, 802, 803.

Furthermore, for the combining shown in FIG. 8, image specific (e.g. for each image 801, 802, 803) offsets may be applied.

In the following, inventive embodiments and aspects will be described in a chapter “Preface”, in a chapter “Fixed classifications”, in a chapter “Model Architecture for Simplified CNN”, in chapter “Clipping Operator”, in a chapter “Complexity of Simplified CNN based in-loop filter” and in a chapter “Encoder/Decoder”.

Also, further embodiments will be defined by the enclosed claims.

It should be noted that any embodiments as defined by the claims can be supplemented by any of the details (features and functionalities) described in the above mentioned chapters or in the above or in the following discussed embodiments, referring, inter alia to FIGS. 1 to 8.

Also, the embodiments described in the above mentioned chapters (for example as well referred to as sections) can be used individually, and can also be supplemented by any of the features in another chapter, or by any feature included in the claims or by any feature of the above or thereafter discussed embodiments.

Also, it should be noted that individual aspects described herein can be used individually or in combination. Thus, details can be added to each of said individual aspects without adding details to another one of said aspects.

Moreover, features and functionalities disclosed herein relating to a method can also be used in an apparatus (configured to perform such functionality). Furthermore, any features and functionalities disclosed herein with respect to an apparatus can also be used in a corresponding method. In other words, the methods disclosed herein can be supplemented by any of the features and functionalities described with respect to the apparatuses.

Also, any of the features and functionalities described herein can be implemented in hardware or in software, or using a combination of hardware and software, as will be described in the section “implementation alternatives”.

In the following, inter alia, embodiments related to simplified CNN based inloop filter with fixed classifications are discussed. In other words, the following chapters 1 to 6 may be titled “Simplified CNN based inloop filter with fixed classifications”.

### 1 Preface

In this section (e.g. technical report), we present a (e.g. simplified) neural network based, e.g. CNN based, in-loop filter incorporating, optionally fixed, classifications. One, or even the, main purpose of this approach may, for example, be to reduce the computational complexity of neural network based, e.g. CNN-based, in-loop filter. According to some embodiments, for this, trained kernels in, e.g. in each, convolutional layer may, for example, be adaptively selected by classification outputs. As an example, it may require about 300-400 multiplications per sample and 20 k-160 k trained parameters depending on the number of classes from classifications and some hyper parameter for the proposed neural network, e.g. CNN, model. Some experimental results will be added later.

### 2 Fixed Classification

More than one, e.g. a plurality, for example, three, classifications may be applied to select trained kernels for samples, e.g. for each sample, to be filtered. One of the classifications may be the ALF classification, e.g. used in VTM and ECM. Two additional classifications SD₁ and SD₂ based on sample difference may, for example, also be applied. In this section, we describe those classifications used in our simplified CNN based in-loop filter. It is to be noted that embodiments are not limited to three classifications and in particular not exclusively to the below discussed classifications. In particular, the respective number of classes given in the following are examples, in order to exemplify embodiments of the invention. However, more, less or different classifications and classes and class derivation methods and in particular classification outputs may be defined.

### 2.1 ALF Classification

For sample locations (i,j), e.g. for each sample location (i, j), two classification outputs A and D may be calculated, for example, over n×n block B with (i, j)∈B, e.g. using Laplacian activity and/or directionality. The classification outputs A and D may, for example, give 5 classes respectively. Then a respective, e.g. even each, sample location (i, j) may be classified into one of 25 classes, for example, by the following:

C=A+5D

In addition to this, for example four, average gradient values (e.g. along the horizontal, vertical and diagonal directions) may, for example, be calculated over the block B, which optionally gives a directional class index T∈{0,1,2,3} for (i, j). Combining C and T may, for example, define the following ALF classification for n×n block:

ALF_{n×n}=(A+5D)+25·T

Hence, in line with the above, it is to be noted again that a block-wise classification can be performed, e.g. as in the original design of ALF classification, e.g. using 4×4 (or 2×2) block-wise classifications.

Note that classification output T based on average gradient values is originally used to determine a type of geometry transform to be applied to the ALF filter coefficients in VTM.

A modified version of ALF_{n×n} has been introduced for ECM. For this, the derivation of classification outputs A and D from ALF_{n×n} may, for example, be modified to have 8 and 20 classes respectively so that the total number of classes from this new classification is 8×20=160. Now, combining directional class T∈{0,1,2,3} as well as the modified classification outputs Ã and \tilde{D} gives

ECM_ALF_{n×n}=(Ã+8\tilde{D})+160·T

We refer to [1], [2] for more detailed description on ALF_{n×n} and ECM_ALF_{n×n}.

### 2.2 Sample Difference (SD) Based Classification

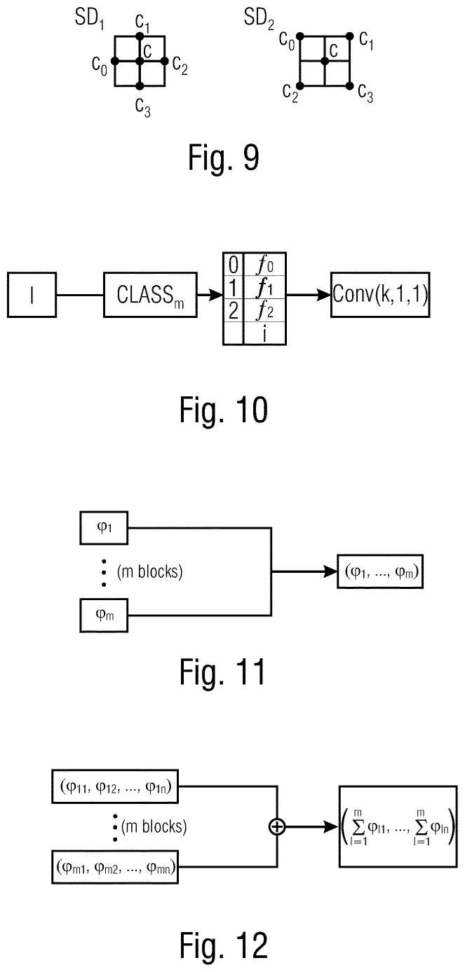

Similar to the edge-classification in SAO, it may, for example, be applied for 3×3 block comprising or containing sample location (i, j) to be classified. There may, for example, be two types of classifications SD₁ and SD₂, e.g. depending on how neighboring samples c in the 3×3 block are chosen, e.g. as illustrated in FIG. 9. For example for each sample c located at (i, j), a sample difference based classifier C(dₗ) defined in (2.1) may, for example, give 3 class indices for each l=0,1,2,3 and some, optionally fixed, threshold T>0.

FIG. 9 shows a schematic example for 4 neighboring samples c₀, c₁, c₂, c₃ used in sample difference based classifications, SD₁ and SD₂ according to embodiments of the invention.

$$C ( {d}_{l} ) = \{ \begin{matrix}0 , & \vert {d}_{l} \vert < T \\ 1 , & {d}_{l} \geq T \\ 2 , & {d}_{l} \leq - T\end{matrix} and {d}_{i} = c - {c}_{l} for l = 0 , 1 , 2 , 3 \qquad ( 2.1 )$$

We now define SD₁ (or SD₂) by

$${SD}_{1} ( or {SD}_{2} ) = {\sum }_{l = 0}^{3} {3}^{l} \cdot C ( {d}_{l} ) \qquad ( 2.2 )$$

The sample difference based classifications SD₁ and SD₂ give 3⁴=81 classes.

Note that (2.1) can be extended to incorporate multiple threshold parameters T₀, . . . , T_{N-1}, for example, as follows:

$$C ( {d}_{l} ; {T}_{0} , … , {T}_{N - 1} ) = \{ \begin{matrix}0 , & \vert {d}_{l} \vert < {T}_{0} \\ n , & \vert {d}_{l} \vert ∈ [ {T}_{n - 1} , {T}_{n} ) and {d}_{l} \geq 0 \\ n + N , & \vert {d}_{l} \vert ∈ [ {T}_{n - 1} , {T}_{n} ) and {d}_{l} < 0\end{matrix}$$

for n=1, . . . , N where T_{N}=∞. Using C(d_{L}; T₀, . . . , T_{N-1}), we now define our sample difference based classification SD₁(T₀, . . . , T_{N-1}) by

$${SD}_{1} ( {T}_{0} , … , {T}_{N - 1} ) = {\sum }_{l = 0}^{3} {( 2 N + 1 )}^{l} \cdot C ( {d}_{l} ; {T}_{0} , … , {T}_{N - 1} ) \qquad ( 2.3 )$$

and SD₂ (To, . . . , T_{N-1}) is defined similarly.

When N=1, we have SD₁(T₀) and SD₂ (T₀) and they are SD₁ and SD₂ defined in (2.2) if we set T₀=T.

Hence, referring to the above chapter 2, in general, an image filter according to embodiments of the invention may optionally be configured to perform the first, e.g. SD₁ or SD₂, sample-wise, e.g. pixel-wise, (or block-wise) classification (e.g. sample difference classification, e.g. sample difference classification as explained above), e.g. fixed classification, e.g. non-neurally performed classification, of the picture as a block based and sample difference (e.g. according to eqn. (2.1), e.g. using dₗ) dependent classification.

Furthermore, optionally, an image filter according to embodiments of the invention may be configured to obtain, for respective samples or blocks, e.g. each sample, of the picture, an information about a difference of a respective sample to its neighboring samples and to perform, for a respective sample, a threshold comparison (e.g. according to eqn. (2.1)), e.g. at least one threshold comparison (e.g. using threshold parameters T₀, . . . , T_{N-1}), using the information about the differences (e.g. dₗ), in order to perform the first classification.

Furthermore, optionally, an image filter according to embodiments of the invention may be configured to perform the second sample-wise, e.g. pixel-wise, (or block-wise) classification, e.g. fixed classification, e.g. non-neurally performed classification, (e.g. ALF classification, e.g. ALF classification as explained above) of the picture as a block based activity, e.g. Laplacian activity, dependent and/or block based directionality dependent classification, e.g. as explained in 2.1.

### 3 Model Architecture for Simplified CNN

Our simplified CNN comprises, or for example consists of, 4 layers and kernels in each of the layers (e.g. except for the last layer) may be selected by classifications. It is to be noted that embodiments are not limited to a certain number of layers. Hence, according to embodiments more or less layers may be used. Therefore, the core part of our simplified CNN may, for example, be to apply convolution with a trained kernel selected by a classification. This is (e.g. can be represented as) an extension of convolutional layer denoted by Conv(k, 1,1) where a trained k×k kernel may be applied, for example, for a single input channel to obtain, for example a single, output channel. Three entries in (k, 1,1) may, for example, specify, the size of 2D kernel and the number of input/output channels respectively. We first illustrate this main basic layer used in our CNN based in-loop filter.

3.1 Convolutional Layer with a Fixed Classification

Convolution with a selected kernel f_{c} may, for example, be applied for a single input channel I. This basic layer denoted by CConvₘ(k, 1,1) is defined in (2,2) where λ_{C}_{_{c}} is the characteristic function of a class C_{c} computed by a given classification CLASSₘ.

Here, m is a classification index to indicate a type of classification to be applied in (2.2). For m=1,2,3, we choose, for example, ALF classification ALF_{n×n} (or ECM_ALF_{n×n}), SD₁ and SD₂ respectively (e.g. a first, a second and an ancillary classification).

$${\sum }_{c = 1}^{N} ( I * {f}_{c} ) \cdot {χ}_{{C}_{c}} \qquad ( 2.2 )$$

In (2,2), a classification CLASSₘ is optionally first applied for a luma frame (e.g. 101 in FIGS. 1 and 2 using classification unit 110) which may be the input data of our CNN based in-loop filter. This may construct classes C_{c} for c=1, . . . , N in (2.2) (e.g. corresponding to classes a and b as discussed in the context of FIGS. 1 and 2). The number of classes N may, for example, depend on which classification is applied (Hence, referring to FIG. 2, A and B may be different numbers). For instance, if ALF classification ALF_{n×n} is applied (e.g. as second classification), we have, for example, N=100 while N=81 for SD₁ (T) and SD₂ (T) (e.g. where one or the other represents the first classification). In other words, according to embodiments different classifications may comprise different numbers of classes. Finally, we define CConvₘ(k, 1, n) by applying the basic layer CConvₘ(k, 1,1) n times to obtain n output channels g₁, . . . , gₙ and this is given as

$${g}_{l} = {\sum }_{c = 1}^{N} ( I * {f}_{i , c} ) \cdot {χ}_{{C}_{c}} for l = 1 , , , , n$$

FIG. 10 shows a schematic view of a block diagram, according to an embodiment, of the basic layer CConvₘ(k, 1,1): A fixed classification CLASSₘ is first applied for a frame, e.g. luma frame. Conv(k, 1,1) may, for example, be a convolutional layer where convolution with k×k kernel selected by CLASSₘ is applied for a single input I to obtain a single output.

### 3.2 Addition/Concatenation Layer

In this section, we illustrate two additional layers used in our simplified CNN based in-loop filter. The first one is a concatenation layer where m input channels φ₁, . . . , φₘ are concatenated to form a single output tensor comprising, or for example consisting of, φ₁, . . . , φₘ. This is illustrated in FIG. 11.

FIG. 11 shows a schematic view of a block diagram of concatenation layer according to an embodiment.

Hence, the above approach may be used in order to obtain concatenated results of respective first and second further convolutions.

Finally, the second layer is addition layer where component-wise (and e.g. sample-wise) addition is applied for m input tensors (φₗ₁, . . . , φₗₙ) comprising, or for example even consisting of, n components φₗ₁, . . . , φₗₙ for l=1, . . . , m. This optionally gives a single output tensor as

$$( {\sum }_{l = 1}^{m} {φ}_{l 1} , … , {\sum }_{l = 1}^{m} {φ}_{ln} )$$

FIG. 12 shows a schematic view of a block diagram of addition layer according to an embodiment.

### 3.3 Model Architecture

Utilizing layers we described in the sections 3.1-3.2, we now define a model architecture (e.g. an example thereof) for our simplified CNN based in-loop filter. It comprises, or for example consists of, 4 layers and the basic layers CConvₘ may, for example, be applied in the first three consecutive layers (1^{st}-3^{rd} layers) as illustrated in FIG. 13a. Note that the same classifications CLASSₘ may, for example, be used in all basic layers CConvₘ for m=1,2,3 respectively and optionally each classification CLASSₘ may, for example be applied for a frame Y (for example frame y, 1301, as shown in FIG. 13a), e.g. luma frame Y (for example luma frame y). In the 2^{nd} layer, as individually optional features, additional input data, the prediction signal (Pred), the input frame of deblocking filter (DBF) and QP parameter (QP) as well as a luma frame Y are used and the non-linear activation function, as an example ReLu, is finally applied. In the 3^{rd} layer, as an example, the basic blocks CConv₁(3,1,1), CConv₂(3,1,1) and CConv₃(3,1,1) are applied for each of p channels, e.g. input channels. After that, concatenation and addition layer may, for example, be applied to obtain, a plurality of, e.g. 3, channels outputs. In the, for example, last layer, convolutional layer Conv(3,3,1) may be applied. Note that there is a special hyper parameter p which may, for example, determine the number of output channels in the 2^{nd} layer.

FIG. 13a shows a schematic block diagram of simplified CNN with fixed classifications according to an embodiment.

CNN Based in-Loop Filter:

Having defined a model architecture of CNN based in-loop filter, we can now define our CNN based in-loop filter, for example, as follows (see e.g. FIG. 13b).

$$\hat{y} = y + {\sum }_{k = 1}^{m} {ϕ}_{k} ( y {\vert}^{Θ )}$$

where y is the reconstructed input frame and φ₁, . . . , φₘ denote the final output channels of a CNN based in-loop filter (e.g. the final output channels from a model architecture illustrated in FIGS. 13a and 13b) with a set of all trained parameters Θ. Here, m is the number of fixed classifications and m=3 in this case (e.g. as shown in FIGS. 13a and 13b).

### 4 Clipping Operator

For the basic layers CConvₘ(5,1,1), e.g. in the 1^{st} layer, the convolution operator may, for example, be replaced by the following non-linear filtering:

$${\sum }_{i} f ( i ) tanh ( ρ ( i ) ( y ( x + i ) - y ( x ) ) ) \qquad ( 5.1 )$$

where i denotes the sample locations in the support of 2D kernel f and ρ are trained parameters. Note that the same trained parameters ρ may, for example, be used for all basic layers CConvₘ(5,1,1).

Hence, according to embodiments of the invention, the image filter may optionally be configured to perform, in the sequence of one or more first convolutions, a first non-linear filtering, e.g. clipping, and to perform, in the sequence of one or more second convolutions, a second non-linear filtering, e.g. clipping.

Furthermore, according to embodiments of the invention, the image filter may optionally be configured to perform the first and second non-linear filtering, e.g. according to eqn. (5.1), e.g. using a clipping operator, using a same set of trained, sample-wise parameters, e.g. p, and sample-wise selected filtering kernels, e.g. f (i).

### 5 Complexity of Simplified CNN Based In-Loop Filter

The computational complexity (given as multiplications per sample) of our CNN based in-loop filter may, for example, depend on the parameter p defined in FIG. 13a. From the model architecture illustrated in FIG. 13a, it is easy to compute # (e.g. number) of multiplications per sample when our CNN based in-loop filter is applied for 256×256 block-we set the padding size to be 6. For p=6 (and 8), we have, for example, 358 (and 433) multiplications per sample for 256×256 input block. For this, multiplications with trained parameters ρ(i) in (5.1) are also counted. The total number of parameters used in a single CNN model in FIG. 13a may depend on the parameter p and classifications CLASSₘ for the basic layers CConvₘ. Table 2 shows an example for the total number of parameters and multiplications per sample for our CNN based in-loop filter with different choices of CLASSₘ and p.

| | | # mul/ | |
|---|---|---|---|
| Classifications (CLASSₘ) | p | sample | # parameters |
| ALF, SD₁ (T), SD₂ (T) | 6 | 358 | 22k |
| ALF, SD₁ (T), SD₂ (T) | 8 | 433 | 27k |
| ECM_ALF, SD₁ (T), SD₂ (T) | 6 | 358 | 67k |
| ECM_ALF, SD₁ (T), SD₂ (T) | 8 | 433 | 83k |
| ECM_ALF, SD₁ (T₀, T₁), | 6 | 358 | 160k |
| SD₂ (T₀, T₁) | | | |

There are two types of CNN models we trained depending on the resolution class of training dataset.

The first type may be trained over classes A-B (high resolution) while the remaining classes C-D (low resolution) may be used for the second type. We choose different block size n×n for ALF_{n×n} and ECM_ALF_{n×n} depending on those two types. For this, we choose n=6 for classes C-D and n=12 for classes A-B.

Hence, in general, according to embodiments, the classification (in particular a block size for class determination) may be adapted based on a resolution class of the dataset comprising the picture.

### 6 Encoder/Decoder

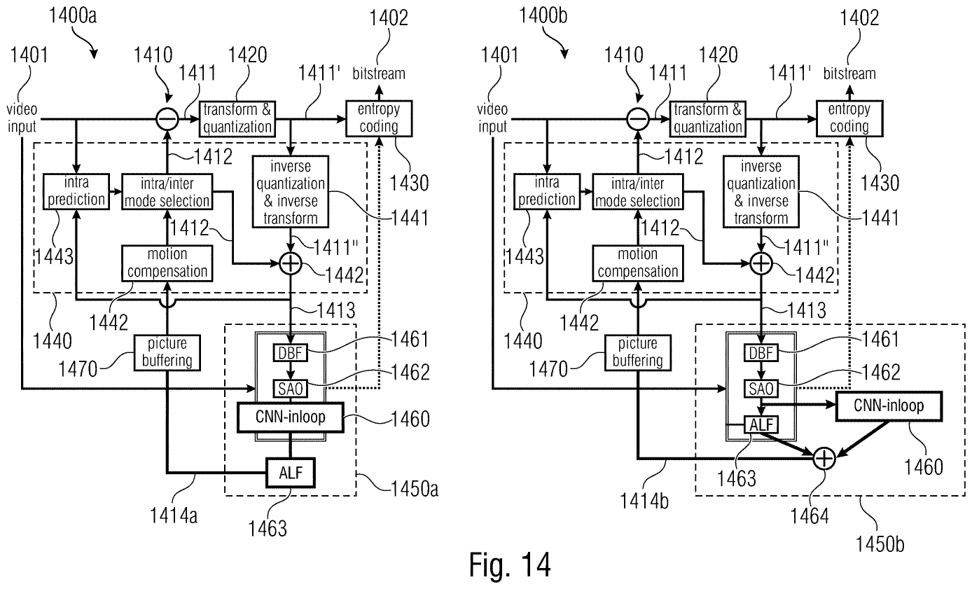

FIG. 14 shows a schematic view of a video encoder block diagram for simplified CNN based in-loop filter according to embodiments of the invention:

Left: CNN in-loop filter is sequentially applied before adaptive loop filter (ALF) is applied.

Right: CNN in-loop filter is jointly applied with adaptive loop filter (ALF)

FIG. 14 shows an example for encoder architectures 1400a, 1400b, according to embodiments of the invention. Encoders 1400a, b may, for example, be configured to obtain a video input 1401, and to provide an information about the video input 1401 (e.g. as an encoded representation) in a bitstream 1402, for example, using block based predictive encoding. Video input 1401 may hence comprise a sequence of pictures or images Y.

As shown in FIG. 14, a respective encoder 1400a, b may be configured to use transform-based residual coding and to subject a prediction residual signal 1411 to spatial-to-spectral transformation and quantization, 1420, to encode the transformed and quantized prediction residual signal 1411′, thus obtained, into the data stream 1402.

Internally, a respective encoder 1400a, b may comprise a prediction residual signal former 1410, which may generate the prediction residual 1411, so as to measure a deviation of a prediction signal 1412 from the original signal, i.e. from pictures Y of video inputs 1401. The prediction residual signal former 1411 may, for instance, be a subtractor, which subtracts the prediction signal from the original signal.

Encoder 1400a,b may optionally comprise, as shown, an entropy coder 1430, which may entropy code the prediction residual signal as transformed and quantized into data stream 1402. The prediction signal 1412 may optionally be generated by a prediction stage 1440.

To this end, the prediction stage 1440 may internally, as is shown in FIG. 14, comprise an inverse quantization and inverse transform unit 1441, which dequantizes and retransforms (i.e. using a spectral-to-spatial transformation) prediction residual signal 1411′, so as obtain a spatial-domain prediction residual signal 1411″. A combiner 1442 of the prediction stage 1440 may then recombine, such as by addition, the prediction signal 1412 and the prediction residual signal 1411″, so as to obtain a reconstructed signal 1413.

Furthermore, the encoders 1400a, b comprise respective filtering modules 1450a and 1450b, so as to obtain, based on reconstructed signal 1413, respective filtered reconstructed signals 1414a and 1414b.

The filtering modules comprise at least one image filter according to an embodiment. In the examples of FIG. 14, as an optional feature, image filter 1460 is shown as a CNN-inloop filter.

Additionally, as shown in FIG. 14, the filtering modules 1440a, 1440b may comprise one or more additional filters, such as DBF 1461, SAO 1462 and/or ALF filters 1463 Furthermore, respective filters may be arranged serially, e.g. as shown in module 1450a, or in parallel. Any combination of serially and parallely arranged filters may be used according to embodiments. Outputs of parallelly arranged filters, such as ALF 1463 and image filter 1460 in module 1450b, may be combined (e.g. added, see summation 1464, e.g. in a weighted manner).

Hence, in general, according to embodiments, the image filter may be arranged in sequence to the ALF filter or in parallel to the ALF filter in the prediction loop. In particular, the image filter may be arranged in parallel to the ALF filter in the prediction loop and a respective encoder, as well as a respective decoder comprising said prediction loop, may be configured to determine a weighted sum, e.g. c·CNN_inloop+ALF, of an output of the ALF filter and of an output of the image filter in order to reconstruct the picture, e.g. frame of video stream 1401.

An input signal for the filtering module may, optionally, be, as shown, the video input 1401. The result of the filtering is provided to a picture buffer 1470. From there, the filtered picture may be provided to a motion compensation unit 1442 of the prediction stage 1440, for Inter-Mode prediction. Furthermore, signal 1413, as well as video input 1401 may be provided to an intra prediction module 1443 for intra prediction. An optional Intra/Inter Mode Selection Unit 1444, may select or combine Intra and/or Intra Prediction signals in order to provide the prediction signal 1412.

Hence, it is to be noted that image filters according to embodiments may be implemented in any of the encoder architectures as shown in FIG. 14, in particular as in-loop filters. They may be arranged serially or in parallel with other filters, for example so that an output of the image filter may be subject to a weighted summation of another filter output.

A respective decoder may comprise the same or respectively corresponding features as disclosed above.

Next, reference is made to the example of the image filter 1460 in the form of a CNN in-loop filter.

To train models (e.g. convolution kernels for different classes of different classifications, e.g. for different layers of the filter) for CNN in-loop filter, the reconstructed frames before ALF may, for example, be used. The first model (e.g. intra-model) may be trained on I frames while the 2nd model (e.g. inter-model) may be trained on B frames. Here, multiple models can, for example, be trained for the first model and the second model, for example depending on QP values and/or resolution classes. Whether the CNN-model corresponding to the frame type (e.g. I frame or B frame) is to be applied may, for example, be signaled on a frame-level and optionally decided by an RD-decision at the encoder. If a CNN in-loop filter is applied, it can optionally be switched on and off, for example, on a CTU-level where the switch may be signaled. There may, for example, be two settings for applying a CNN in-loop filter. The first option may be to apply a CNN in-loop filter before ALF is applied (see e.g. left in FIG. 14). On the other hand, the second option may be to jointly apply a CNN in-loop filter and ALF (see e.g. right in FIG. 14) as illustrated in FIG. 14. For this, the final reconstructed frame may be given by

c·CNN_inloop+ALF

where CNN_inloop and ALF are the output reconstructed frames by a CNN in-loop filter and ALF and c is a scaling coefficient, for example, derived at the encoder. The coefficient c may, for example, be signaled on a frame-level.

Hence, it is to be noted that in general, a model selection may be performed based on an information about a resolution of the dataset comprising a respective picture and/or based on a respective prediction mode. Furthermore, the model selection may be performed based on QP values, e.g. in addition or alternatively.

A respective classification may comprise a plurality (e.g. two or more) subsets of classes, which are chosen depending on an information about a resolution, e.g. on average, of the picture or of a resolution class, e.g. A, B, C, D, of the dataset comprising the picture, e.g. according to a resolution class of the dataset comprising the picture or video comprising the picture as a frame.

Hence, in particular, the previously discussed first convolution kernels may, for example, be selected from the first set of convolution kernels, based on the first classification, in case a resolution of the picture or of a resolution class of the dataset comprising the picture is below a threshold or, for example, in a low-resolution class and the first convolution kernels may be selected from a different first set of convolution kernels, based on the first classification, in case the resolution, e.g. on average, of the picture or of a resolution class, e.g. A, B, C, D, of the dataset comprising the picture is above or equal to the threshold, or, for example in a high-resolution class, for example, at least higher than the low resolution class.

Accordingly, the first and second, sample-wise or block-wise, classification of the picture may, for example, be performed depending on an information about a resolution of the picture or of a resolution class of the dataset comprising the picture.

In particular, an information, whether the picture is an I frame or a B frame may be used to select respective convolution kernels.

Hence, it is to be noted, that image filters according to embodiments may, for example, be configured to select, e.g. sample-wise or block-wise, convolution kernels out of different sets of convolution kernels, depending on a type of the picture, e.g. such as whether the picture is an I frame or a B frame.

Such an information may be provided by a respective encoder picture-wise. The encoder may hence provide an information indicating whether a CNN model (e.g. convolution kernels thereof) corresponding to an I frame or to a B frame is to be used. Accordingly, the encoders 1400a, b may comprise respective optional additional classificator stages, in order to encode such an information in the bitstream.

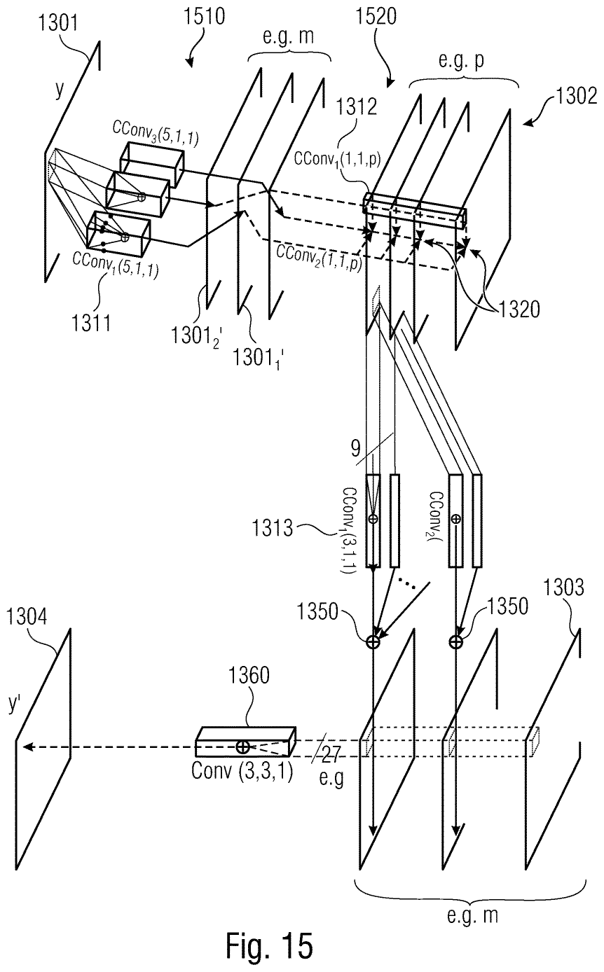

In the following, reference is made again to FIG. 13a. Based on the architecture (e.g. the model architecture of a CNN based in-loop filter according to embodiments) of FIG. 13a an example for an image filtering according to embodiments, comprising optional features, will be explained. In addition, reference is made to FIG. 15. FIG. 15 shows a schematic view of an image filtering procedure according to the architecture as shown in FIG. 13a.

As discussed before, a picture y, 1301, e.g. corresponding to picture 101 in FIGS. 1 and 2, may be provided to image filter 1300a, the image filter 1300a may hence obtain picture 1301.

First, picture 1301 may be classified, e.g. as discussed in the context of FIGS. 1 and 2 as well as FIG. 10. In the example of FIG. 13a three classifications (e.g. m=3) are performed. The before-discussed classifications ALF, SD₁ and SD₂ may be used therefore, however, other classifications, and in particular only a first and second classification, are possible as well.

Based on the classifications, the convolution kernels for the first, second and third layer are selected sample-wise (as discussed earlier optionally block-wise) and classification-wise (e.g. as discussed in the context of FIGS. 1 and 2). Hence, filter 1300a is configured to perform a first and second sample-wise classification of the picture 1301.

As an example, for a respective sample, e.g. at location (i,j), based on the first classification, a first class may be assigned. This class may define the convolution kernel for the respective sample and hence location for CConv1 (5,1,1), 1311, the convolution kernel for the sample at location (i,j) of the filtered (by CConv1 (5,1,1)) version 13011′ of the picture (e.g. the first intermediate convolution output) for CConv1 (1,1,p), 1312, and the respective convolution kernel for respective CConv1 (3,1,1), 1313.

The convolutions in layer 1 and layer 2 may hence form the sequence of one or more (here two, see 1510 and 1520 in FIG. 15) first, second, and here optionally third (e.g. ancillary) convolutions on the picture 1301, using the selected first, second, and here third (e.g. ancillary) convolution kernels, in order to provide a plurality p of first, second, and here third (e.g. ancillary) convolution outputs.

Hence, according to the example of FIGS. 13a and 15, as an optional feature, first and second subsets of convolution kernels are used, a respective first subset defining the convolution kernels (e.g. as discussed in the context of FIG. 5) for CConvₗ(5, 1, 1), l=1,2,3, and a respective second subset defining the convolution kernels (e.g. as discussed in the context of FIG. 6) CConvₗ(1,1,p). However, it is to be noted that for CConvₗ(5,1,1), l=1,2,3 a non-linear filtering (e.g. clipping operator, e.g. clipping operator as defined in (5.1) in section or respectively chapter 4) may also be used or applied.

Hence, in general it is to be noted that according to embodiments, an image filter may, for example, be configured to perform, in the sequence of one or more first and/or second and/or ancillary convolutions, a first and/or second and/or ancillary non-linear filtering.

Filtered image 1301₁′ may hence correspond to image 411 and filtered image 1302₂′ may correspond to image 421 in FIGS. 6 and 7. It is to be noted that the terms image and picture and frame may be used either way. In contrast to FIG. 5, the kernel size in the example of FIGS. 13a and 15 is 5×5, instead of 3×3.

Accordingly, p first convolution outputs 1301₁″ may correspond to pictures 611, 612, 613 (with p=3) of FIGS. 6 and 7, and the p second convolution outputs 13012″ may correspond to pictures 621, 622, 623 (with p=3) of FIG. 7.

As an optional feature, the respective p first, second and in the example of FIG. 13a even third (e.g. ancillary) convolution outputs may be combined as a sum, using summation 1320, in order to obtain a plurality of p combined convolution outputs 1302. This may correspond to the approach as shown in FIG. 8, wherein samples of images, from filtering based on convolution kernels of different classifications, are added. Hence the p convolution outputs 1302 may correspond to the images 801, 802, 803 (with p=3). In FIG. 15, an example for p>3 is shown.

As indicated in FIG. 15, kernels of respective second subsets of selected kernels, e.g. for the CConvₗ(1,1,p) may correspond to weighting factors for the sample-wise summation.

As illustrated in FIG. 15, according to embodiments, optionally, the image filter may be configured to keep a number of channels per classification-wise filtering constant for convolutions based on the first subsets (e.g. one single channel input Y, 1301 and respective one single channel intermediate outputs 1301₁′ and 1301₂′) and to increase a number of channels classification-wise filtering or convolutions based on respective second subsets (e.g. respective single channel intermediate inputs 1301₁′ and 1301₂′ and multi-channel outputs 1301₁″ and 1301₂″).

As another optional feature, image filter 1300a is configured to combine the first and second convolution outputs using a sample-wise addition of respective first and second convolution outputs and a subsequent nonlinear activation function 1330, here as an example a ReLu. It is to be noted that other non-linearities may be used as well.

As an example, in general, according to embodiments, activation functions 1330 such as leaky ReLu, tanh, binary step function, SELU, ELU, signoid/logistic and/or parametric ReLu may be used.

As mentioned before, an addition of bias terms may optionally be applied for each of p combined convolution outputs (e.g. as a single (trained) constant, e.g. bₖ, added to each output channel, e.g. φₖ, before provision to the nonlinear activation function.

As another optional feature, here as an example in the second layer, an additional convolution, here as an example, Conv(1,4,p) using the frame Y, 1301, a predicted version of the frame Pred, a reconstructed version of the frame, here an input of a deblocking filter DBF, and a quantization parameter, here QP, in order to provide a plurality of additional intermediate convolution outputs 1301₄″ for the subsequent combination 1320 and activation 1330 is performed.

It is to be noted that this additional convolution (e.g. as indicated by Conv(1,4,p)) may optionally be chosen independent from the classification (e.g. hence no subscript I).

As another optional feature, image filter 1300a comprises a further, third, convolution layer for further first, second and here third (e.g. ancillary) convolutions. As shown in FIG. 15, each of the p channels 1302 may be provided to the third layer to be convolved according to classification-(and sample-) wise selected convolution kernels.

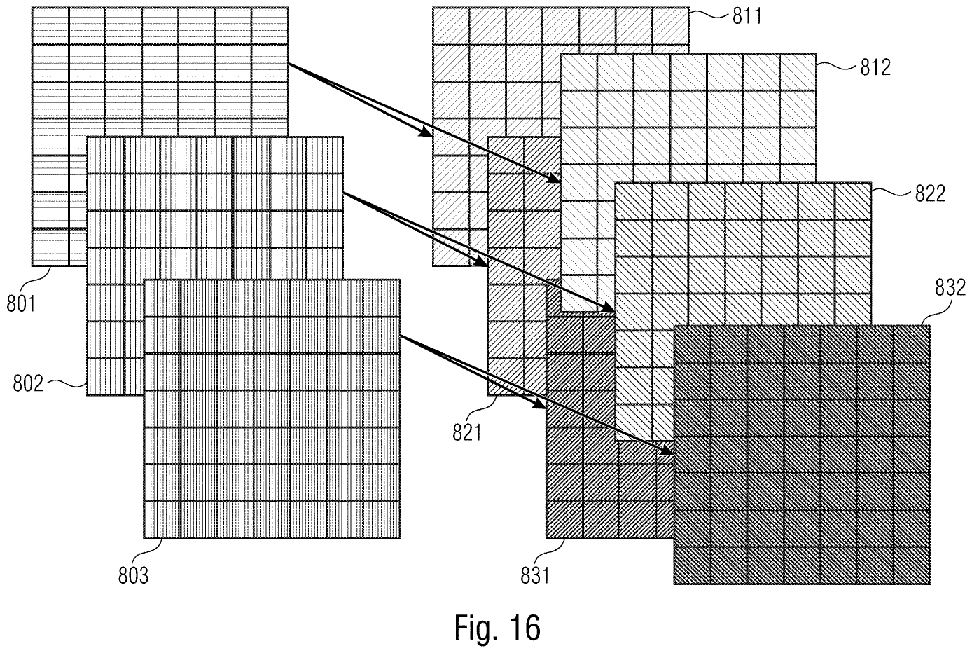

Reference is made in addition to FIG. 16, showing a simplified example with p=3 combined convolution output 801, 802, 803 (e.g. corresponding to p outputs 1302). Each of those images may be filtered classification-wise, e.g. as an example as indicated in FIG. 13a for sample-wise 3×3 kernels.

Results of the respective first and second further convolution (hence, e.g. 811 and 812; e.g. 821 and 822; e.g. 831 and 832, e.g. using a further subset of the first convolution kernels and for example, using a further subset of the second convolution kernels) may be concatenated, 1340, e.g. as discussed in the context of FIG. 11. As another optional feature, the concatenated results may be combined, in order to obtain a plurality, e.g. m, of combined concatenated results 1303.

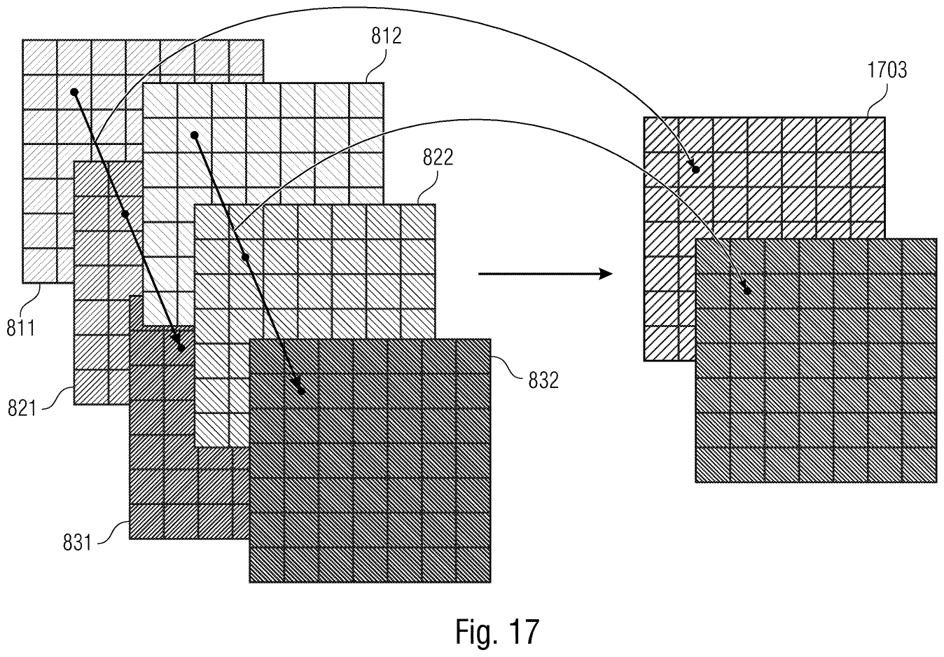

In the example of FIGS. 13a (and 15, wherein for simplicity, the concatenation is not shown), the combination may optionally be performed as a sample-wise sum. Optionally, in contrast to sum 1330, this sum may be performed over pictures of a same-classification filtering, see FIG. 17. A result thereof, namely images 1703 (here as an example for m=2) may hence correspond to combined concatenated results 1303.

As another optional feature, filter 1300a comprises an output convolution layer, here as an example, a fourth layer, to perform an output convolution, here using Conv(3,3,1), 1360, of the combined concatenated results 1303 in order to provide a filtered version of the picture 1304, which may represent a residual between a target, e.g. uncompressed original picture and a reconstructed version of the picture, e.g. y, 1301, or which may represent an approximation of the target picture, e.g. in case (not shown), a residual obtained by the image filter 1300 is added to its input picture 1301.

As shown in FIG. 13a, the output convolution is optionally independent from the classification (no subscript I). In particular, the output convolution may, hence, for example, be independent from the first and second sample-wise classification. For example, the output convolution, e.g. Conv(3,3,1), of the combined concatenated results 1303 may comprise picture-specific filtering coefficients.

Next, reference is made to FIG. 13b. FIG. 13b shows a schematic block diagram of a simplified CNN in-loop image filter with fixed classifications according to an embodiment. Image filter 1300b comprises the same features as shown in FIG. 13a, apart from an additional summation 1370.

As discussed earlier and shown in FIG. 13b, image filter 1300a may optionally be configured to improve a residual signal, which may represent a difference between a target signal, e.g. an original uncompressed version of the picture, and a reconstructed version of the picture, e.g. y:

$$\hat{y} = y + {\sum }_{k = 1}^{m = 3} {ϕ}_{k} ( y \vert Θ )$$

Hence, ŷ, 1305, may be an approximation for the original uncompressed picture. It is to be noted that in the example of FIG. 13b, m is, as an optional feature, set to 3. Furthermore, it is to be noted that embodiments are not limited to three classifications. Referring to FIG. 14, y may hence be signal 1413, or a preprocessed version thereof, e.g. based on DBF and/or SAO filtering and y may be an approximation of a frame of the video input 1401, so that the output of the image filter itself allows reducing the residual 1411. In a respective encoder, a coding efficiency may hence be improved.

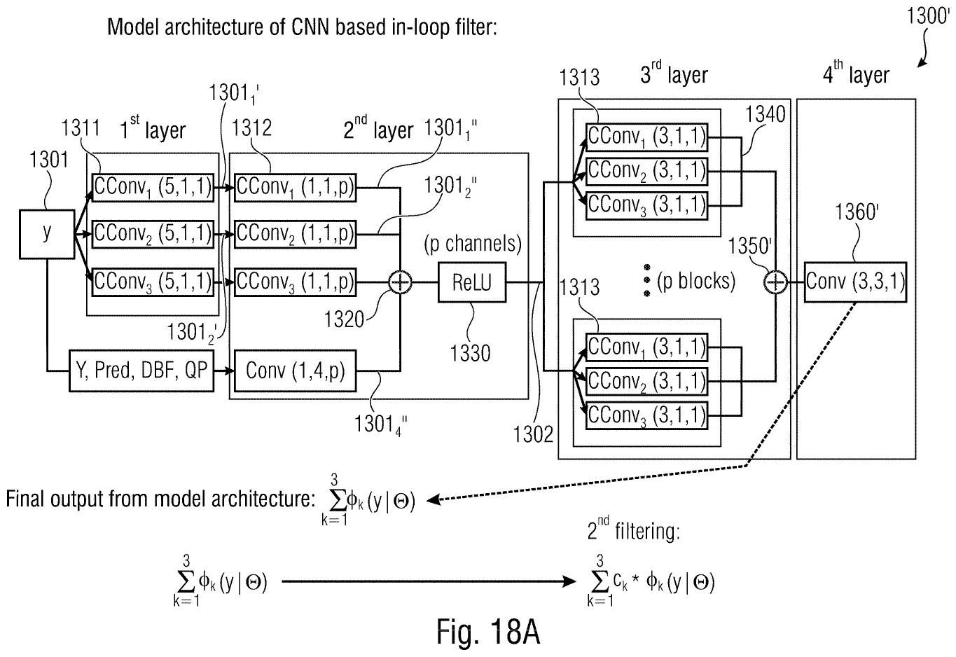

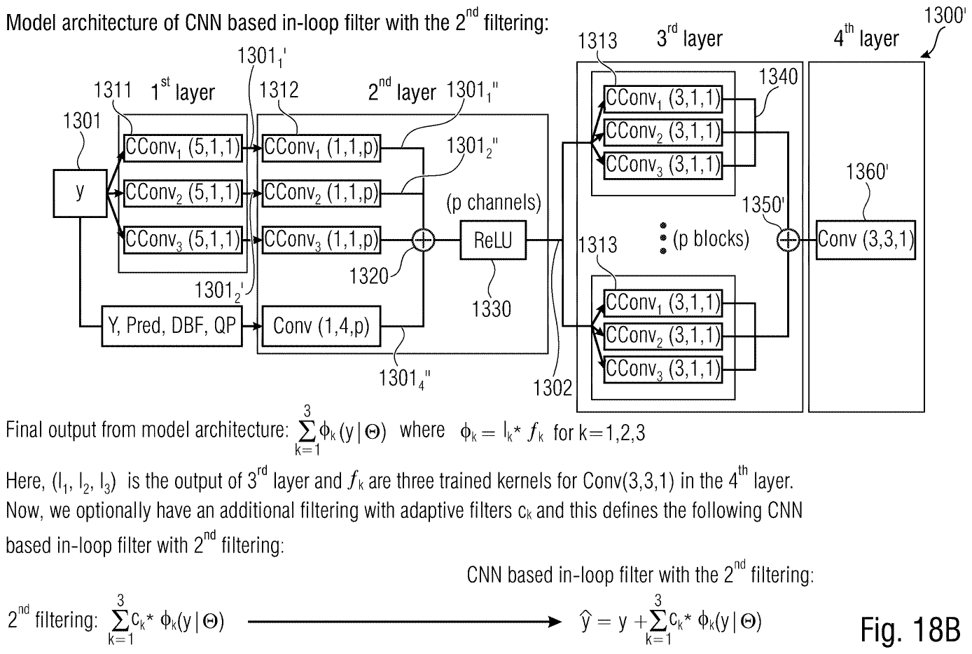

Next, reference is made to FIG. 18a. FIG. 18a shows a schematic view of the filter according to FIG. 13a, further highlighting the optional output convolution in the fourth layer. As shown in such a, for example, last layer, an additional, e.g. 2^{nd} filtering may be performed based on filters cₖ.

As shown, as an optional feature, according to embodiments, adaptive, e.g. m×m symmetric, filters ck may be derived at the encoder and signaled, for example per frame. Furthermore, optionally, a merging algorithm (like ALF merging alg.) can be applied to reduce the number of the filters cₖ. It is optionally also signaled on a CTU level whether additionally the 2nd filtering is to be applied or not.

In other words, FIG. 18a shows a use of adaptive coefficients (or filters) which are used in the last layer (e.g. 4th layer) as additional filtering. Those coefficients may, for example, not be trained, but adaptively derived, for, e.g. each, input frame at the encoder.

Referring to FIG. 18b, the above-discussed approach is discussed again in the context of in-loop filtering. FIG. 18b shows the architecture of FIG. 18a, further highlighting the application of kernels fₖ to output images I₁, I₂ and I₃. The third layer outputs (I₁, I₂, I₃) may correspond to the images 1703 as shown in FIG. 17 (for three classifications).

In other words, for the example shown in FIG. 18b, here, (I₁, I₂, I₃) is the output of 3^{rd} layer and fₖ are three trained kernels for Conv(3,3,1) in the 4^{th} layer. Now, we optionally have an additional filtering with adaptive filters ck and this defines the following CNN based in-loop filter with the 2^{nd} filtering:

$${\sum }_{k = 1}^{3} {c}_{k} * {ϕ}_{k} ( y \vert Θ )$$

Referring to the optional architecture having summation 1305, for improving a residual error, an in-loop filtering may be performed according to:

$$\hat{y} = y + {\sum }_{k = 1}^{m} {c}_{k} * {ϕ}_{k} ( y \vert Θ ) .$$

Hence, in other words, a CNN based in-loop filter with 2^{nd} Filtering may be based on incorporating the 2^{nd} filtering with adaptive filters cₖ (adaptively derived depending on y), so we have (see also FIG. 18b, wherein, as an example, m=3) the above discussed formula:

$$\hat{y} = y + {\sum }_{k = 1}^{m} {c}_{k} * {ϕ}_{k} ( y {\vert}^{Θ )}$$

or in accordance to the examples of FIG. 13a, b and FIG. 18a, b, wherein as an optional feature m=3 respectively:

$$\hat{y} = y + {\sum }_{k = 1}^{m} {c}_{k} * {ϕ}_{k} ( y \vert Θ )$$

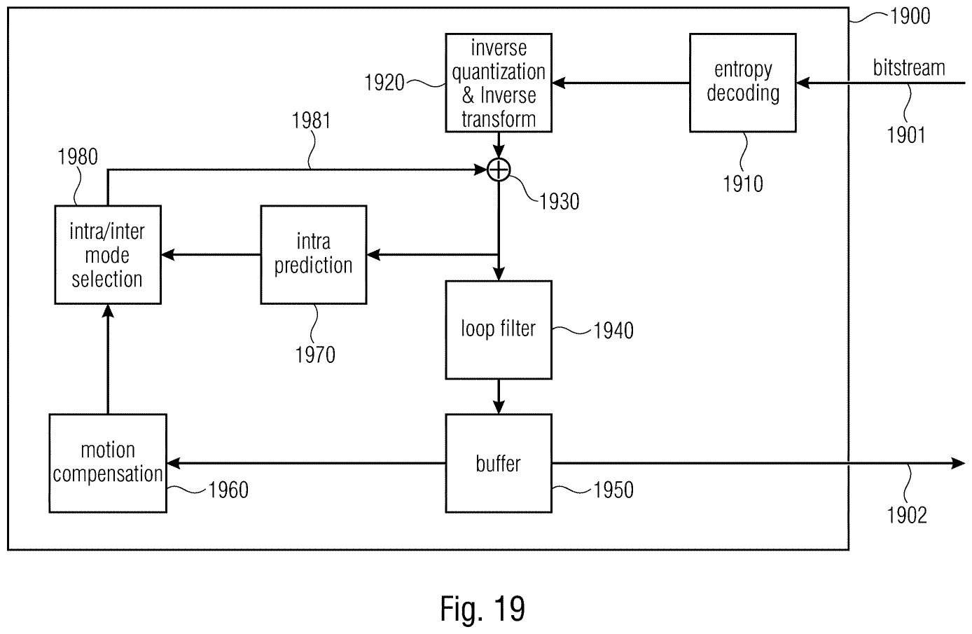

Next, reference is made to FIG. 19. FIG. 19 shows a schematic view of a decoder according to embodiments of the invention. FIG. 19 shows decoder 1900, comprising an entropy decoding unit 1910, an inverse quantization and inverse transform unit 1920, a summation 1930, a loop filter unit 1940, an image buffer 1950, a motion compensation unit 1960, an intra prediction unit 1970 and an intra/inter mode selection unit 1980.

It is to be noted that a decoder according to embodiments may comprise corresponding features, as a respective encoder, e.g. as disclosed in the context of FIG. 14. Decoder 1900, or to be more specific, loop filter unit 1940 comprises an image filter, e.g. such as 100, 1300a, 1300b, 1300′, 1460.

Hence, decoder 1900 is configured to obtain an encoded representation of a picture from a bitstream 1901, e.g. the bitstream 1402 as provided by a corresponding encoder.

Furthermore, the decoder 1900 is configured to reconstruct, based on the bitstream 1901, the picture (e.g. as an output of loop filter unit 1940) using block-based predictive decoding and a prediction loop, the prediction loop comprising the image filter.

The prediction loop may comprise, as shown in FIG. 19, loop filter unit 1940 and image buffer 1950, as well as the intra prediction unit 1970, motion compensation unit 1960 and mode selection unit 1980, in order provide a prediction result 1981 to summation 1930.

Furthermore, the decoder is configured to buffer the reconstructed picture in the image buffer 1950. As shown, optionally, the reconstructed picture 1902 may be provided as an output of decoder 1900.

The loop filter 1940 comprises an image filter according to embodiments, and optionally, in addition, an ALF filter, wherein the image filter is arranged in sequence to the ALF filter or in parallel to the ALF filter in the prediction loop. Alternatively, the loop filter 1940 may comprise an ALF filter, wherein the image filter is arranged in parallel to the ALF filter in the prediction loop and the decoder is configured to determine a weighted sum of an output of the ALF filter and of an output of the image filter, in order to reconstruct the picture. Hence, decoder 1900 may comprise corresponding filter structures as shown in FIG. 14.

As another optional feature, decoder 1900 may be configured to receive a switching signal and to enable or disable the image filter based on the switching signal.

In the following, additional embodiments and aspects of the invention will be described which can be used individually or in combination with any of the features and functionalities and details described herein.

A first aspect relates to an image filter (e.g. 100, 1300a, 1300b, 1300′, 1460), which may, for example, be a prediction loop filter, e.g. for video coding, or which may, for example, be a neural network image filter, or which may, for example, be e.g. convolutional neural network filter.

The image filter is configured to obtain, e.g. receive, e.g. be provided with, a picture (e.g. 101, 1301), e.g. a frame of a video, e.g. a frame of a video stream, e.g. a reconstructed version of a picture, e.g. a reconstructed version of a target picture. The image filter is further configured to perform, sample-wise, e.g. pixel-wise; e.g. for each sample, or block-wise, e.g. for each block, a first classification (e.g. fixed classification, e.g. non-neurally performed classification, e.g. by use of FIR filters) of the picture, e.g. in order to map sample indices and/or samples, e.g. each sample, of the picture to classes of a first set of classes. The image filter is further configured to perform, sample-wise, e.g. pixel-wise; e.g. for each sample, or block-wise, e.g. for each block, a second, e.g. different from the first, classification (e.g. fixed classification, e.g. non-neurally performed classification, e.g. by use of FIR filters) of the picture, e.g. in order to map sample indices and/or samples, e.g. each sample, of the picture to classes of a second set of classes, which is, for example, different from the first set of classes. The image filter is further configured to select, sample-wise, e.g. pixel-wise; e.g. for each sample, or block-wise, first convolution kernels (e.g. 311, 312, 601, 620) (e.g. sample-wise matrices of dimension k×k, e.g. sample-wise tensors, e.g. sample-wise scalars) from a first set of convolution kernels, based on the first classification. The image filter is further configured to select, sample-wise, e.g. pixel-wise; e.g. for each sample, or block-wise, second convolution kernels (e.g. 321, 322) (e.g. sample-wise matrices of dimension k×k, e.g. sample-wise tensors, e.g. sample-wise scalars) from a second set of convolution kernels, based on the second classification. The image filter is further configured to perform, in one or more convolution layers, e.g. in a second layer, e.g. in a first and second layer, of the image filter, a sequence (e.g. 1510, 1520) of one or more first, e.g. sample-wise, e.g. block-wise, convolutions on the picture or on a pre-processed, e.g. filtered or convoluted, version of the picture, using the selected first convolution kernels (e.g. using individually selected kernels for each sample or block), in order to provide a plurality of first convolution outputs (e.g. 1301₁′, 611, 612, 613), e.g. p first convolution outputs, e.g. p first channels. The image filter is further configured to perform, in the one or more convolution layers, e.g. in a second layer, e.g. in a first and second layer, of the image filter, a sequence (e.g. 1510, 1520) of one or more second, e.g. sample-wise, e.g. block-wise, convolutions on the picture or on the pre-processed, e.g. filtered or convoluted, version of the picture, using the selected second convolution kernels (e.g. using individually selected kernels for each sample or block), in order to provide a, e.g. same, plurality of second convolution outputs (e.g. 1301₂′, 621, 621, 623), e.g. p second convolution outputs, e.g. p second channels. The image filter is further configured to combine, e.g. add, e.g. add in an element-wise manner, the first and second convolution outputs, in order to obtain a, e.g. same, plurality of combined convolution outputs (e.g. 1302, 801, 802, 803), e.g. p combined convolution outputs, e.g. p combined channels.

According to a second aspect, the image filter (e.g. 100, 1300a, 1300b, 1300′, 1460) comprises a plurality of convolution layers, wherein the image filter is configured to select the first and second convolution kernels sample-wise, e.g. individually for each sample and/or each sample location, e.g. pixel-wise, or block-wise, classification-wise (e.g. individually for each sample and depending on whether a first or second type of classification is currently performed for the respective sample) and layer-wise (e.g. individually for each sample and depending on whether a first or second type of classification is currently performed for the respective sample and depending on a respective layer for which a convolution kernel is to be selected) (e.g. so as to select for each sample, in dependence on the respective classification (e.g. first or second classification) of the sample (e.g. resulting in a certain class of the first or second classification), different convolution kernels out of a classification dependent set of classes for different layers of the prediction loop filter).

According to a third aspect when referring back to any one of the preceding aspects, the image filter (e.g. 100, 1300a, 1300b, 1300′, 1460) is configured to select, from the first set of convolutional kernels, e.g. from the selected first set of convolution kernels (e.g. 311, 312, 601, 620), sample-wise or block-wise, a first subset of first convolution kernels (e.g. 311, 312) (e.g. 5×5 kernels, e.g. for convolutions in a first layer of the filter, e.g. one of CConv₁(5,1,1), CConv₂(5,1,1), CConv₃(5,1,1)) and a second subset of first convolution kernels (e.g. 601, 620) (e.g. scalar kernels; e.g. scalar weighting factors; e.g. for convolutions or weightings in a second layer of the filter e.g. one of CConv₁(1,1,p), CConv₂(1,1,p), CConv₃(1,1,p)). The image filter is further configured to select, from the second set of convolutional kernels, e.g. from the selected second convolution kernels, sample-wise or block-wise, a first subset of second convolution kernels (e.g. 321, 322) (e.g. 5×5 kernels; e.g. for convolutions in a first layer of the filter, e.g. another one of CConv₁(5,1,1), CConv₂(5,1,1), CConv₃(5,1,1)) and a second subset of second convolution kernels (e.g. scalar kernels, e.g. scalar weighting factors; e.g. for convolutions or weightings in a second layer of the filter e.g. another one of CConv₁(1,1,p), CConv₂(1,1,p), CConv₃(1,1,p)). The image filter is further configured to perform the sequence of one or more first convolutions in a sequential, and e.g. sample-wise, manner by convolving (e.g. 1510) the picture (e.g. 101, 1301) or the preprocessed version of the picture with respective (e.g. sample-individual, e.g. sample-wise, e.g. for each sample individually selected) first, e.g. selected, convolution kernels (e.g. 311, 312) (e.g. so that an individual first convolution kernel is selected for each sample) of the first subset of first, e.g. selected, convolution kernels, e.g. of the first selected convolution kernels, to obtain a first intermediate convolution output (e.g. 1301₁′, 411) and by convolving (e.g. 1520) the first intermediate convolution output with respective (e.g. sample-individual, e.g. sample-wise, e.g. for each sample individually selected) first convolution kernels (e.g. 601, 620) of the second subset of first, e.g. selected, convolution kernels, in order to provide the plurality of first convolution outputs (e.g. 1301₁″, 611, 612, 613). The image filter is further configured to perform the sequence of one or more second convolution in a sequential, and e.g. sample-wise, manner by convolving (e.g. 1510) the picture (e.g. 101, 1301) or a preprocessed version of the picture with respective (e.g. sample-individual, e.g. sample-wise, e.g. for each sample individually selected) second, e.g. selected, convolution kernels (e.g. 321, 322) (e.g. so that an individual second convolution kernel is selected for each sample) of the first subset of second, e.g. selected, convolution kernels (e.g. of the second selected convolution kernels) to obtain a second intermediate convolution output (e.g. 1301₂′, 421) and by convolving (e.g. 1520) the second intermediate convolution output with respective (e.g. sample-individual, e.g. sample-wise, e.g. for each sample individually selected) second convolution kernels of the second subset of second, e.g. selected, convolution kernels, in order to provide the plurality of second convolution outputs (e.g. 1301₂″, 621, 622, 623).

According to a fourth aspect when referring back to the third aspect, the first intermediate convolution output (e.g. 1301₁′, 411) and the second intermediate convolution output (e.g. 1301₂′, 411) are, e.g. each, of a single channel.

According to a fifth aspect when referring back to any one of the third or fourth aspects, the first convolution outputs (e.g. 1301₁″, 621, 621, 623) and the second convolution outputs (e.g. 1301₂″, 621, 622, 623) are of multiple channels (e.g. of a same number of channels, e.g. of p channels), and the image filter is configured to increase a number of channels relative to the first intermediate convolution output (e.g. 1301₁′, 411) and the second intermediate convolution output (e.g. 1301₂′, 411) by convolving (e.g. 1520) the first intermediate convolution output and the second intermediate convolution output with the second subset of first convolution kernels (e.g. 601, 620) and the second subset of second convolution kernels. The image filter is further configured to perform, sample-wise or block-wise, a summation of the first convolution outputs (e.g. 1301₁″, 611, 611, 613) and the second convolution outputs (e.g. 1301₂″, 621, 622, 623), so that the second subset of the first convolution kernels and the second subset of the second convolution kernels form weighting factors, so as to form, along with the sample-wise or block-wise summation, a sample-wise weighted sum or a block-wise weighted sum.

According to a sixth aspect when referring back to any one of the preceding aspects, the mage filter (e.g. 100, 1300a, 1300b, 1300′, 1460) is configured to perform, in the sequence (e.g. 1510, 1520) of one or more first convolutions, a first non-linear filtering, e.g. clipping; and perform, in the sequence (e.g. 1510, 1520) of one or more second convolutions, a second non-linear filtering, e.g. clipping.

According to a seventh aspect when referring back to the sixth aspect, the image filter (e.g. 100, 1300a, 1300b, 1300′, 1460) is configured to perform the first and second non-linear filtering (e.g. according to eqn. (5.1), e.g. using a clipping operator) using a same set of trained, sample-wise or block-wise, parameters, e.g. p, and, sample-wise or block-wise, selected filtering kernels, e.g. f (i).

According to an eighth aspect when referring back to any one of preceding aspects, the image filter (e.g. 100, 1300a, 1300b, 1300′, 1460) is configured to provide the plurality, e.g. p, of second convolution outputs (e.g. 1301₂″, 621, 622, 623) and the plurality, e.g. p, of combined convolution outputs (e.g. 801, 802, 803, 1302) with a same number, e.g. p, of convolution outputs as the plurality, e.g. p, of first convolution outputs (e.g. 1301₁″, 611, 612, 613).

According to a ninth aspect when referring back to any one of the preceding aspects, the image filter (e.g. 100, 1300a, 1300b, 1300′, 1460) is configured to combine the first (e.g. 1301₁″, 611, 612, 613) and second convolution outputs (e.g. 1301₂″, 621, 622, 623) using a, sample-wise or block-wise, addition (e.g. 1320) of respective first and second convolution outputs and a subsequent nonlinear activation function (e.g. 1330), e.g. ReLu, (e.g. p combined convolution outputs).

According to a tenth aspect when referring back to any one of the preceding aspects, the image filter (e.g. 100, 1300a, 1300b, 1300′, 1460) is configured to combine the first (e.g. 1301₁″, 611, 612, 613) and second (e.g. 1301₂″, 621, 622, 623) convolution outputs by using a, sample-wise or block-wise, addition (e.g. 1320) of respective first and second convolution outputs, in order to obtain a plurality, e.g. p, intermediate combined convolution outputs, adding (e.g. 1320) an offset to respective, e.g. each, intermediate combined convolution outputs, in order to obtain a plurality of offset intermediate combined convolution outputs, provide the plurality of offset intermediate combined convolution outputs to a nonlinear activation function, e.g. ReLu, in order to obtain the plurality, e.g. p, of combined convolution outputs (e.g. 1302, 801, 802, 803) (e.g. so that before the nonlinear activation is applied, an addition of bias terms is applied for each of p intermediate combined convolution outputs (e.g. a single (trained) constant b_k (e.g. bₖ) may be added to each output channel \phi_k, e.g. φₖ)).

According to an eleventh aspect when referring back to any one of the preceding aspects, the image filter (e.g. 100, 1300a, 1300b, 1300′, 1460) is configured to perform, in the one or more convolution layers, an additional convolution, e.g. Conv(1,4,p), using at least one of the picture (e.g. 101, 1301) (e.g. using the frame or one or more processed, e.g. filtered, versions thereof, e.g. Y), predicted version of the picture (e.g. of the frame; e.g. Pred), reconstructed version of the picture (e.g. of the frame; e.g. a reconstructed frame before DBF; e.g. an input frame for the deblocking filter (DBF)), and/or quantization parameter, e.g. QP, in order to provide a plurality, e.g. p, of additional intermediate convolution outputs (e.g. 1301₄″); and combine (e.g. as a summation, e.g. as a weighted summation) the first and second convolution outputs and the additional intermediate convolution outputs, in order to obtain the plurality of combined convolution outputs, e.g. p combined convolution outputs.

According to a twelfth aspect when referring back to the eleventh aspect, the image filter (e.g. 100, 1300a, 1300b, 1300′, 1460) is configured to combine (e.g. as a summation, e.g. as a weighted summation) the first (e.g. 1301₁″, 611, 612, 613) and second (e.g. 1301₂″, 621, 622, 623) convolution outputs and the additional intermediate convolution outputs (e.g. 1301₄″), in order to obtain a plurality of intermediate combined convolution outputs. The image filter is further configured to add an offset to a respective, e.g. each, intermediate combined convolution outputs, in order to obtain a plurality of offset intermediate combined convolution outputs. The image filter is further configured to provide the plurality of offset intermediate combined convolution outputs to a nonlinear activation function, e.g. ReLu, in order to obtain the plurality, e.g. p, of combined convolution outputs (e.g. 1302, 801, 802, 803) (e.g. so that before the nonlinear activation is applied, an addition of bias terms is applied for each of p intermediate combined convolution outputs (e.g. a single (trained) constant b_k (e.g. bₖ) may be added to each output channel (k)) (e.g. so that the addition of bias terms and ReLU are applied after combining first and second convolution outputs and the additional intermediate convolution outputs).

According to a thirteenth aspect when referring back to the eleventh or twelfth aspect, the additional convolution is independent from the first and second, sample-wise or block-wise, classification (e.g. not parametrized in a classification dependent manner, e.g. having only one single set of, e.g. sample-wise, convolution kernels, e.g, wherein the convolution kernels of the additional convolution are chosen independent from the first and second classification).

According to a fourteenth aspect when referring back to any of the preceding aspects, the image filter (e.g. 100, 1300a, 1300b, 1300′, 1460) is configured to perform, in a further convolution layer, e.g. in a third layer, of the image filter, for a respective combined convolution output (e.g. 1302, 801, 802, 803) (e.g. for each combined convolution output, e.g. for each of the p convolution outputs, e.g. for respective, e.g. each, convolution outputs of a second layer), a first further convolution (e.g. one of Conv₁(3,1,1), Conv₂(3,1,1), Conv₃(3,1,1)) using a further subset of the first, e.g. selected, convolution kernels (e.g. 311, 312, 601, 620), e.g. 3×3 convolution kernels, and a second further convolution (e.g. another one of Conv₁(3,1,1), Conv₂(3,1,1), Conv₃(3,1,1)) using a further subset of the second, e.g. selected, convolution kernels, e.g. 3×3 convolution kernels. The image filter is further configured to concatenate (e.g. 1340) results (e.g. 811, 812, 813, 821, 822, 823) of the respective first and second further convolution, in order to obtain a plurality of concatenated results, e.g. p×m pictures. The image filter is further configured to combine (e.g. 1350) (e.g. add, e.g. perform a sample-wise addition) the concatenated results (e.g. 811, 812, 813, 821, 822, 823), in order to obtain a plurality, e.g. m, of combined concatenated results (e.g. 1303, 1703).

According to a fifteenth aspect when referring back to the fourteenth aspect, the image filter (e.g. 100, 1300a, 1300b, 1300′, 1460) is configured to add (e.g. 1350), sample-wise or block-wise, concatenated results (e.g. 811, 812, 813) of the first further convolutions of respective combined convolution outputs. The image filter is further configured to add (e.g. 1350), sample-wise or block-wise, concatenated results of second further convolutions (e.g. 821, 822, 823) of respective combined convolution outputs; in order to combine (e.g. add, e.g. perform a sample-wise addition, e.g. over dimension p of the) the concatenated results of the respective combined convolution outputs and to provide the plurality (e.g. m, e.g. according to the number of classifications used) of combined concatenated results (e.g. 1303, 1703), e.g. combined concatenated convolution outputs.

According to a sixteenth aspect when referring back to any one of the fourteenth or fifteenth aspects, the image filter (e.g. 100, 1300a, 1300b, 1300′, 1460) is configured to perform, in an output convolution layer (e.g. in a fourth layer, e.g. in a last layer) of the image filter, an output convolution, e.g. Conv(3,3,1), of the combined concatenated results (e.g. 1303, 1703) in order to provide a filtered version (e.g. 102, 1304) of the picture.

According to a seventeenth aspect when referring back to the sixteenth aspect, the output convolution is independent from the first and second sample-wise classification (e.g. not parametrized in a classification dependent manner, e.g. having only one single set of, e.g. sample-wise, convolution kernels, e.g, wherein the convolution kernels of the output convolution are chosen independent from the first and second classification).

According to an eighteenth aspect when referring back to the sixteenth aspect, the output convolution, e.g. Conv(3,3,1), of the combined concatenated results (e.g. 1303, 1703) comprises picture-specific filtering coefficients, wherein, for example, respective coefficients are not trained but adaptively derived for each input frame at the encoder.

According to a nineteenth aspect when referring back to any one of the preceding aspects, the image filter (e.g. 100, 1300a, 1300b, 1300′, 1460) is configured to select, sample-wise or block-wise, the first convolution kernels (e.g. 311, 312, 601, 620) (e.g. sample-wise matrices of dimension k×k, e.g. sample-wise tensors, e.g. sample-wise scalars) from the first set of convolution kernels, based on the first classification, in case a resolution, e.g. on average, of the picture (e.g. 101, 1301) or of a resolution class, e.g. A, B, C, D, of the dataset comprising the picture is below a threshold or, for example in a low-resolution class. The image filter is further configured to select, sample-wise, first convolution kernels (e.g. sample-wise matrices of dimension k×k, e.g. sample-wise tensors, e.g. sample-wise scalars) from a different first set of convolution kernels, based on the first classification, in case the resolution, e.g. on average, of the picture or of a resolution class, e.g. A, B, C, D, of the dataset comprising the picture is above or equal to the threshold or, for example in a high-resolution class, e.g. at least higher than the low resolution class.

According to a twentieth aspect when referring back to any one of the preceding aspects, the image filter (e.g. 100, 1300a, 1300b, 1300′, 1460) is configured to perform the first and second, sample-wise, e.g. pixel-wise, or block-wise, classification (e.g. fixed classification, e.g. non-neurally performed classification) of the picture (e.g. 101, 1301) (e.g. in order to map sample indices and/or samples, e.g. each sample, of the picture to classes of a first set of classes) depending on an information about a resolution, e.g. on average, of the picture or of a resolution class, e.g. A, B, C, D, of the dataset comprising the picture, e.g. according to a resolution class of the dataset comprising the picture or video comprising the picture as a frame.

According to a twenty-first aspect when referring back to any one of the preceding aspects, the image filter (e.g. 100, 1300a, 1300b, 1300′, 1460) is configured to select, sample-wise or block-wise, first convolution kernels (e.g. sample-wise matrices of dimension k×k, e.g. sample-wise tensors, e.g. sample-wise scalars) from the first set of convolution kernels or from a different first set of convolution kernels, based on the first classification, depending on a type of the picture (e.g. 101, 1301), e.g. whether the picture is an I frame or a B frame. The image filter is further configured to select, sample-wise or block-wise, second convolution kernels (e.g. sample-wise matrices of dimension k×k, e.g. sample-wise tensors, e.g. sample-wise scalars) from the second set of convolution kernels or from a different second set of convolution kernels, based on the second classification, depending on the type of the picture, e.g. whether the picture is an I frame or a B frame.

According to a twenty-second aspect when referring back to the twenty-first aspect, the image filter (e.g. 100, 1300a, 1300b, 1300′, 1460) is configured to obtain, e.g. receive or determine, a picture-wise information (e.g. indicating whether a CNN model corresponding, e.g. trained for use with, to an I frame or to an B frame is to be used) whether a respective set, e.g. of first and/or second set, of convolution kernels or a respective different set, e.g. of first and/or second set, of convolution kernels is to be used to select respective, e.g. first or second, convolution kernels.

According to a twenty-third aspect when referring back to any one of the preceding aspects, the image filter (e.g. 100, 1300a, 1300b, 1300′, 1460) is configured to perform the first, e.g. different from the second, sample-wise, e.g. pixel-wise, or block-wise, classification (e.g. fixed classification, e.g. non-neurally performed classification) of the picture (e.g. 101, 1301) (e.g. in order to map sample indices and/or samples, e.g. each sample, of the picture to classes of a first set of classes, which is, for example, different from the second set of classes) as a block based and sample difference dependent classification.

According to a twenty-fourth aspect when referring back to the twenty-third aspect, the image filter (e.g. 100, 1300a, 1300b, 1300′, 1460) is configured to obtain, for respective samples, e.g. each sample, of the picture (e.g. 101, 1301) or for a respective block of the picture, an information about a difference of a respective sample to its neighboring samples or an information about a difference of a respective block to its neighboring blocks. The image filter is further configured to perform, for a respective sample or block, a threshold comparison, e.g. at least one threshold comparison, using the information about the differences, in order to perform the first classification, optionally, the same may be applied for the second classification.

According to a twenty-fifth aspect when referring back to any one of the twenty-third or twenty-fourth aspects, the image filter (e.g. 100, 1300a, 1300b, 1300′, 1460) is configured to perform the second, sample-wise, e.g. pixel-wise, or block-wise, classification (e.g. fixed classification, e.g. non-neurally performed classification) of the picture (e.g. 101, 1301) (e.g. in order to map sample indices and/or samples, e.g. each sample, of the picture to classes of a second set of classes) as a block based activity, e.g. Laplacian activity, dependent and/or block based directionality dependent classification.

According to a twenty-sixth aspect when referring back to any one of the preceding aspects, the image filter (e.g. 100, 1300a, 1300b, 1300′, 1460) is configured to perform at least one ancillary, e.g. third, sample-wise, e.g. pixel-wise, or block-wise, classification (e.g. fixed classification, e.g. non-neurally performed classification such by use of FIR filters) of the picture (e.g. 101, 1301) (e.g. in order to map sample indices and/or samples, e.g. each sample, of the picture to classes of an ancillary set of classes). The image filter is further configured to select, sample-wise or block-wise, ancillary convolution kernels (e.g. sample-wise matrices of dimension k×k, e.g. sample-wise tensors, e.g. sample-wise scalars) from at least one ancillary set of convolution kernels, based on the at least one ancillary classification. The image filter is further configured to perform, in the one or more convolution layers of the image filter, at least one sequence (e.g. 1510, 1520) of one or more ancillary convolutions, on the picture or on the pre-processed, e.g. filtered or convoluted, version of the picture, using the selected ancillary convolution kernels, in order to provide a plurality of ancillary convolution outputs, e.g. p ancillary convolution outputs. The image filter is further configured to combine (e.g. add, e.g. add in an element-wise manner) the first (e.g. 1301₁″, 611, 612, 613), second (e.g. 1301₂″, 621, 622, 623) and ancillary convolution outputs, in order to obtain the, e.g. same, plurality of combined convolution outputs (e.g. 801, 802, 803, 1302), e.g. p combined convolution outputs.

According to a twenty-seventh aspect when referring back to the twenty-sixth aspect, the image filter (e.g. 100, 1300a, 1300b, 1300′, 1460) is configured to perform, in the sequence (e.g. 1510, 1520) of one or more ancillary convolutions, an ancillary non-linear filtering, e.g. clipping.

According to a twenty-eighth aspect when referring back to any one of the preceding aspects, the picture (e.g. 101, 1301) is a reconstructed (e.g. previously subjected to an inverse quantization and inverse transformation, e.g. inverse transformation from spectral to spatial domain, e.g. after compression and transmission in a bitstream, e.g. after compression and decompression in an encoder in a prediction loop) version of a target (e.g. original, e.g. uncompressed) picture; and the, e.g. in-loop, image filter is configured to provide, based on the plurality of combined convolution outputs (e.g. 1302, 801, 802, 803), an output signal for improving (e.g. reducing a residual error) a residual between the target picture and the reconstructed picture.

A twenty-ninth aspect relates to a decoder comprising an image filter (e.g. 100, 1300a, 1300b, 1300′, 1460) according to any of the preceding aspects and an image buffer (e.g. 1470), wherein the decoder is configured to obtain an encoded representation (e.g. an encoded video stream, e.g. a stream of encoded frames) of the picture (e.g. 101, 1301), e.g. a frame of a video, from a bitstream (e.g. 1402); reconstruct, based on the bitstream, the picture using block-based predictive decoding and a prediction loop (e.g. 1440, 1450a,b, 1470), the prediction loop comprising the image filter; buffer the reconstructed picture (e.g. 102, 1304) in the image buffer.

According to a thirtieth aspect when referring back to the twenty-ninth aspect, the decoder comprises an ALF (e.g. 1463), e.g. adaptive loop, filter, wherein the image filter (e.g. 100, 1300a, 1300b, 1300′, 1460) is arranged in sequence to the ALF filter or in parallel to the ALF filter in the prediction loop (e.g. 1440, 1450a,b, 1470).

According to a thirty-first aspect when referring back to the twenty-ninth aspect, the decoder comprises an ALF filter (e.g. 1463), wherein the image filter (e.g. 100, 1300a, 1300b, 1300′, 1460) is arranged in parallel to the ALF filter in the prediction loop (e.g. 1440, 1450a,b, 1470); and wherein the decoder is configured to determine a weighted sum (e.g. 1464), e.g. c·CNN_inloop+ALF, of an output of the ALF filter and of an output of the image filter in order to reconstruct the picture (e.g. 101, 1301).

According to a thirty-second aspect when referring back to any one of the twenty-ninth to thirty-first aspects, the decoder is configured to receive a switching signal, e.g. a CTU-level switch signal, and to enable or disable the image filter (e.g. 100, 1300a, 1300b, 1300′, 1460) based on the switching signal.

A thirty-third aspect relates to an encoder (e.g. 1400a,b) comprising an image filter (e.g. 100, 1300a, 1300b, 1300′, 1460) according to any of the first to twenty-eighth aspects and an image buffer (e.g. 1470), configured to obtain the picture (e.g. 101, 1301), e.g. as a frame of a video input of the encoder; perform a block-based predictive encoding of the picture, using a prediction loop (e.g. 1440, 1450a,b, 1470) comprising the image filter, in order to provide an encoded version of the picture to a bitstream (e.g. 1402).

According to a thirty-fourth aspect when referring back to the thirty-third aspect, the encoder (e.g. 1400a,b) comprises an ALF filter (e.g. 1463), wherein the image filter (e.g. 100, 1300a, 1300b, 1300′, 1460) is arranged in sequence to the ALF filter or in parallel to the ALF filter in the prediction loop (e.g. 1440, 1450a,b, 1470).

According to a thirty-fifth aspect when referring back to the thirty-third aspect, the encoder (e.g. 1400a,b) comprises: an ALF filter (e.g. 1463), wherein the image filter (e.g. 100, 1300a, 1300b, 1300′, 1460) is arranged in parallel to the ALF filter in the prediction loop (e.g. 1440, 1450a,b, 1470); and wherein the apparatus is configured to determine a weighted sum (e.g. 1464), e.g. c·CNN_inloop+ALF, of an output of the ALF filter and of an output of the image filter, in order to perform the block-based predictive encoding of the picture (e.g. 101, 1301).

A thirty-sixth aspect relates to a method for image filtering, the method comprising: obtaining (e.g. receive, e.g. be provided with) a picture (e.g. 101, 1301) (e.g. a frame of a video, e.g. a frame of a video stream); performing, sample-wise, e.g. pixel-wise, or block-wise, a first classification (e.g. fixed classification, e.g. non-neurally performed classification such by use of FIR filters) of the picture (e.g. in order to map sample indices and/or samples, e.g. each sample, of the picture to classes of a first set of classes); performing (e.g. different from the first) sample-wise, e.g. pixel-wise, or block-wise, a second classification (e.g. fixed classification, e.g. non-neurally performed classification such by use of FIR filters) of the picture (e.g. in order to map sample indices and/or samples, e.g. each sample, of the picture to classes of a second set of classes, which is, for example, different from the first set of classes); selecting, sample-wise or block-wise, first convolution kernels (e.g. 311, 312, 601, 620) (e.g. sample-wise matrices of dimension k×k, e.g. sample-wise tensors, e.g. sample-wise scalars) from a first set of convolution kernels, based on the first classification; selecting, sample-wise or block-wises, second convolution kernels (e.g. 321, 322) (e.g. sample-wise matrices of dimension k×k, e.g. sample-wise tensors, e.g. sample-wise scalars) from a second set of convolution kernels, based on the second classification; performing, in one or more convolution layers of the image filter, a sequence (e.g. 1510, 1520) of one or more first, e.g. sample-wise, convolutions on the picture or on the pre-processed version of the picture (e.g. using the picture or one or more processed, e.g. filtered, versions thereof), using the selected first convolution kernels, in order to provide a plurality of first convolution outputs (e.g. 1301₁″, 611, 612, 613) (e.g. p first convolution outputs, e.g. p first channels); performing, in the one or more convolution layers of the image filter, a sequence of one or more second, e.g. sample-wise, convolutions on the picture or on a pre-processed, e.g. filtered or convoluted, version of the picture, using the selected second convolution kernels, in order to provide a, e.g. same, plurality of second convolution outputs (e.g. 1301₂″, 621, 622, 623) (e.g. p second convolution outputs, e.g. p second channels); and combining (e.g. 1320) (e.g. add, e.g. add in an element-wise manner) the first and second convolution outputs, in order to obtain a, e.g. same, plurality of combined convolution outputs (e.g. 801, 802, 803, 1302) (e.g. p combined convolution outputs, e.g. p combined channels).

A thirty-seventh aspect relates to a computer program for performing the method according to the thirty-sixth aspect when the computer program runs on a computer.

Furthermore, embodiments according to the invention comprise an apparatus (e.g. 100, 1300a, 1300b, 1300′, 1460) for neural network based image filtering, the apparatus comprising a convolutional layer and one or more subsequent layers. The apparatus is configured to perform, for each filter kernel set out of a set of filter kernel sets, a picture classification in a spatially sampling manner so as to obtain, for each filter kernel position (e.g. sᵢⱼ, e.g. s_{xy}) of filter kernel positions distributed over the picture (e.g. 101, 1301), a selected local picture classification out of a set of local picture classifications (e.g. aₐ out of {a₁, . . . , a_{A}}, e.g. b_{b} out of {b₁, . . . , b_{B}}) within which each local picture classification is associated with a respective filter kernel out of the respective filter kernel set and a weight for each of weighted sum combinations (see e.g. FIGS. 2, 3 and 13 a,b).

The apparatus is further configured to, in the convolutional layers, subject the picture to, for each filter kernel set out of the filter kernel sets, a convolution using the respective filter kernel set by applying to each filter kernel position the filter kernel (e.g. Kernelₐₐ¹ (i,j)) associated with the selected picture classification obtained for the respective filter kernel position (e.g. sᵢⱼ) so as to obtain, for the respective filter kernel set, a filtered input channel (see e.g. FIGS. 3, 4, 5 and 13 a,b).

The apparatus is further configured to, in the one or more subsequent layers, form the weighted sum combinations of the filtered input channels obtained for the filter kernel sets, with, for each weighted sum combination, weighting, at each filter kernel position, each filtered input channel using the weight which is associated with the selected picture classification obtained for the respective filter kernel position, and based on the weighted sum combinations, determine a filtered picture of the picture (see e.g. FIG. 13 a,b).

### Implementation Alternatives:

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The apparatus described herein, or any components of the apparatus described herein, may be implemented at least partially in hardware and/or in software.

The methods described herein may be performed using a hardware apparatus, or using a computer, or using a combination of a hardware apparatus and a computer.

The methods described herein, or any components of the apparatus described herein, may be performed at least partially by hardware and/or by software.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] M. Karczewicz, L. Zhang, W. Chien and X. Li, “Geometry transformation-based adaptive in-loop filter,” in Proc. Picture Coding Symposium (PCS), pp. 1-5, 2016.
[2] Yao-Jen Chang et al., “Compression efficiency methods beyond VVC” in 21st JVET meeting, no. JVET-U0100, January 2021.

1. Image filter configured to:
acquire a picture;
perform, sample-wise or block-wise, a first classification of the picture;
perform, sample-wise or block-wise, a second classification of the picture;
select, sample-wise or block-wise, first convolution kernels from a first set of convolution kernels, based on the first classification;
select, sample-wise or block-wise, second convolution kernels from a second set of convolution kernels, based on the second classification;
perform, in one or more convolution layers of the image filter, a sequence of one or more first convolutions on the picture or on a pre-processed version of the picture, using the selected first convolution kernels, in order to provide a plurality of first convolution outputs;
perform, in the one or more convolution layers of the image filter, a sequence of one or more second convolutions on the picture or on the pre-processed version of the picture, using the selected second convolution kernels, in order to provide a plurality of second convolution outputs; and
combine the first and second convolution outputs, in order to acquire a plurality of combined convolution outputs.

2. Image filter according to claim 1, configured to:
select, from the first set of convolutional kernels, sample-wise or block-wise, a first subset of first convolution kernels and a second subset of first convolution kernels;
select, from the second set of convolutional kernels, sample-wise or block-wise, a first subset of second convolution kernels and a second subset of second convolution kernels;
perform the sequence of one or more first convolutions in a sequential manner by convolving the picture or the preprocessed version of the picture with respective first convolution kernels of the first subset of first convolution kernels to acquire a first intermediate convolution output and by convolving the first intermediate convolution output with respective first convolution kernels of the second subset of first convolution kernels, in order to provide the plurality of first convolution outputs; and
perform the sequence of one or more second convolution in a sequential manner by convolving the picture or a preprocessed version of the picture with respective second convolution kernels of the first subset of second convolution kernels to acquire a second intermediate convolution output and by convolving the second intermediate convolution output with respective second convolution kernels of the second subset of second convolution kernels, in order to provide the plurality of second convolution outputs.

3. Image filter according to claim 1, wherein:
the first intermediate convolution output and the second intermediate convolution output are of a single channel.

4. Image filter according to claim 3, wherein:
the first convolution outputs and the second convolution outputs are of multiple channels, and
wherein the image filter is configured to:
increase a number of channels relative to the first intermediate convolution output and the second intermediate convolution output by convolving the first intermediate convolution output and the second intermediate convolution output with the second subset of first convolution kernels and the second subset of second convolution kernels; and
perform, sample-wise or block-wise, a summation of the first convolution outputs and the second convolution outputs, so that the second subset of the first convolution kernels and the second subset of the second convolution kernels form weighting factors, so as to form, along with the sample-wise or block-wise summation, a sample-wise weighted sum or a block-wise weighted sum.

5. Image filter according to claim 1, configured to:
provide the plurality of second convolution outputs and the plurality of combined convolution outputs with a same number of convolution outputs as the plurality of first convolution outputs.

6. Image filter according to claim 1, configured to:
combine the first and second convolution outputs using a, sample-wise or block-wise, addition of respective first and second convolution outputs and a subsequent nonlinear activation function.

7. Image filter according to claim 1, configured to:
combine the first and second convolution outputs by
using a, sample-wise or block-wise, addition of respective first and second convolution outputs, in order to acquire a plurality intermediate combined convolution outputs,
adding an offset to respective intermediate combined convolution outputs, in order to acquire a plurality of offset intermediate combined convolution outputs, provide the plurality of offset intermediate combined convolution outputs to a nonlinear activation function,
in order to acquire the plurality of combined convolution outputs.

8. Image filter according to claim 1, configured to:
perform, in the one or more convolution layers, an additional convolution, using at least one of
the picture,
a predicted version of the picture,
a reconstructed version of the picture, and/or
a quantization parameter,
in order to provide a plurality of additional intermediate convolution outputs; and
combine the first and second convolution outputs and the additional intermediate convolution outputs, in order to acquire the plurality of combined convolution outputs.

9. Image filter according to claim 1, configured to:
combine the first and second convolution outputs and the additional intermediate convolution outputs, in order to acquire a plurality of intermediate combined convolution outputs;
add an offset to a respective intermediate combined convolution outputs, in order to acquire a plurality of offset intermediate combined convolution outputs, provide the plurality of offset intermediate combined convolution outputs to a nonlinear activation function,
in order to acquire the plurality of combined convolution outputs.

10. Image filter according to claim 8, wherein the additional convolution is independent from the first and second, sample-wise or block-wise, classification.

11. Image filter according to claim 1, configured to:
perform, in a further convolution layer of the image filter, for a respective combined convolution output, a first further convolution using a further subset of the first convolution kernels and a second further convolution using a further subset of the second convolution kernels;
concatenate results of the respective first and second further convolution, in order to acquire a plurality of concatenated results; and
combine the concatenated results, in order to acquire a plurality of combined concatenated results.

12. Image filter according to claim 11, configured to:
add, sample-wise or block-wise, concatenated results of the first further convolutions of respective combined convolution outputs;
add, sample-wise or block-wise, concatenated results of second further convolutions of respective combined convolution outputs;
in order to combine the concatenated results of the respective combined convolution outputs and to provide the plurality of combined concatenated results.

13. Image filter according to claim 11, configured to:
perform, in an output convolution layer of the image filter, an output convolution of the combined concatenated results in order to provide a filtered version of the picture.

14. Image filter according to claim 13, wherein the output convolution is independent from the first and second sample-wise classification.

15. Image filter according to claim 13,
wherein the output convolution of the combined concatenated results comprises picture-specific filtering coefficients.

16. Image filter according to claim 1, configured to:
perform the first, sample-wise or block-wise, classification of the picture as a block based and sample difference dependent classification.

17. Image filter according to claim 16, configured to:
perform the second, sample-wise or block-wise, classification of the picture as a block based activity dependent and/or block based directionality dependent classification.

18. Image filter according to claim 1, configured to:
perform at least one ancillary, sample-wise or block-wise, classification of the picture;
select, sample-wise or block-wise, ancillary convolution kernels from at least one ancillary set of convolution kernels, based on the at least one ancillary classification;
perform, in the one or more convolution layers of the image filter, at least one sequence of one or more ancillary convolutions, on the picture or on the pre-processed version of the picture, using the selected ancillary convolution kernels, in order to provide a plurality of ancillary convolution outputs;
combine the first, second and ancillary convolution outputs, in order to acquire the plurality of combined convolution outputs.

19. Image filter according to claim 18, configured to:
perform, in the sequence of one or more ancillary convolutions, an ancillary non-linear filtering.

20. Decoder comprising an image filter according to claim 1 and an image buffer, wherein the decoder is configured to:
acquire an encoded representation of the picture from a bitstream;
reconstruct, based on the bitstream, the picture using block-based predictive decoding and a prediction loop, the prediction loop comprising the image filter;
buffer the reconstructed picture in the image buffer.

21. Decoder according to claim 20, configured to:
receive a switching signal and to enable or disable the image filter based on the switching signal.

22. Encoder comprising an image filter according to claim 1 and an image buffer, configured to:
acquire the picture;
perform a block-based predictive encoding of the picture, using a prediction loop comprising the image filter, in order to provide an encoded version of the picture to a bitstream.

23. Method for image filtering, the method comprising:
acquiring a picture;
performing, sample-wise or block-wise, a first classification of the picture;
performing sample-wise or block-wise, a second classification of the picture;
selecting, sample-wise or block-wise, first convolution kernels from a first set of convolution kernels, based on the first classification;
selecting, sample-wise or block-wises, second convolution kernels from a second set of convolution kernels, based on the second classification;
performing, in one or more convolution layers of the image filter, a sequence of one or more first convolutions on the picture or on the pre-processed version of the picture, using the selected first convolution kernels, in order to provide a plurality of first convolution outputs;
performing, in the one or more convolution layers of the image filter, a sequence of one or more second convolutions on the picture or on a pre-processed version of the picture, using the selected second convolution kernels, in order to provide a plurality of second convolution outputs; and
combining the first and second convolution outputs, in order to acquire a plurality of combined convolution outputs.

24. Method for decoding an encoded representation of a picture,
wherein the method comprises acquiring the encoded representation of the picture from a bitstream;
wherein the method comprises reconstructing, based on the bitstream, the picture
by using block-based predictive decoding and a prediction loop, the prediction loop comprising an image filter and
by performing the method according to claim 23; and
wherein the method comprises buffering the reconstructed picture in the image buffer.

25. Method for providing an encoded representation of a picture,
wherein the method comprises acquiring the picture;
wherein the method comprises performing a block-based predictive encoding of the picture,
by using a prediction loop comprising an image filter and
by performing the method according to claim 23,
in order to provide the encoded representation of the picture to a bitstream.

26. A non-transitory digital storage medium having a computer program stored thereon to perform the method of claim 23 when said computer program is run by a computer.

27. A non-transitory digital storage medium having a computer program stored thereon to perform the method of claim 24 when said computer program is run by a computer.

28. A non-transitory digital storage medium having a computer program stored thereon to perform the method of claim 25 when said computer program is run by a computer.

29. Bitstream having encoded therein a picture using the method according to claim 25.
